(19) United States
(12) Patent Application Publication
(10) Pub. No.: US 2017/0098039 A1
(43) Pub. Date: Apr. 6, 2017

(54) PATIENT CONTROLLED APP FOR SHARING PERSONAL HEALTH DATA

(71) Applicant: Digital Healthcare Consulting, LLC, Sullivans Island, SC (US)

(72) Inventors: David Abergel, Fort Worth, TX (US); Kerry D. Solomon, Sullivans Island, SC (US); Laurent J. Attias, Fort Worth, TX (US)

(21) Appl. No.: 15/177,382

(22) Filed: Jun. 9, 2016

Related U.S. Application Data
(60) Provisional application No. 62/235,970, filed on Oct. 1, 2015.

(51) Int. Cl. G06F 19/00; G06Q 10/10

(52) U.S. Cl. CPC G06F 19/322; G06F 19/363; G06Q 10/10; G06F 19/3456

(57) ABSTRACT

A healthcare patient application is configured to interface with healthcare provider's electronic medical records (EMR) systems to send/receive to/from healthcare provider's EMR systems patient medical records using a standardized clinical document that is transmitted by the healthcare provider to a patient application or by the patient to the healthcare provider application and EMR systems. The healthcare provider may approve some or all of the standardized clinical document for integration with their EMR system. Likewise, the patient may approve some or all of the standardized clinical document for integration with the patient's electronic personal health record (E-PHR), the E-PRH being a compilation of the patient's received EMR from one or more healthcare providers. Similarly, the patient may select some of all of the E-PHR for transmission to one or more healthcare provider applications and EMR systems.

### CROSS-REFERENCE TO RELATED APPLICATION

This application claims the benefit of U.S. Provisional Patent Ser. No. 62/235,970 filed Oct. 1, 2015, which is hereby incorporated by reference in its entirety.

### TECHNICAL FIELD

Exemplary embodiments of the present invention relate generally to a system and method for electronic health-related records.

### BACKGROUND AND SUMMARY OF THE INVENTION

The rise of the digital age along with evolving healthcare laws and regulations has spurred a need for Electronic Medical Records (EMRs, a.k.a. Electronic Health Records (EHRs)). Paper records, including systems and methods therefore, fail to provide the level of accessibility, ease of communication, security, privacy, and ease of transfer that patients have come to demand from their healthcare providers and systems. Further, new laws and regulations are beginning to demand the use of EMRs.

Current EMR systems and methods, however, are provider oriented and controlled. These systems place the healthcare provider as the “hub” of their architecture and the patients as the “spokes.” In such systems and methods, the provider has primary control of the EMRs and the Personal Health Information (PHI) for various patients contained therein. The patient may have limited or no access to their EMR. Even if granted access, the EMRs may be communicated in various formats such as Portable Document Format (PDF), text files, or the like. These documents are often fixed once generated and cannot be updated in real time. Regardless, these documents may be of various, incompatible formats and often require manual transcription into the patient's or another healthcare provider's EMR system. This process is not only time consuming and technically difficult, but may discourage the patient or healthcare provider from transferring a patient's files.

Another effect of the provider oriented system is that the patient's medical information is fragmented across their various healthcare providers. An average patient sees multiple healthcare providers, such as a family doctor or general practitioner, specialists, and emergency care providers. Each healthcare provider may have their own EMR system and method, which may not be compatible with the EMR system and method used by the patient's other healthcare providers. The patient or healthcare provider may have to navigate several EMR systems in order to access their complete medical record and get a total picture of their healthcare record, medical history, and other PHI.

This lack of communication may result in a failure to get a complete healthcare picture of the user. Further, new laws and regulations are beginning to demand that patient be permitted meaningful use of their EMRs, which may require the patient to have a comprehensive picture of their total health from all healthcare providers. Therefore, what is needed is a patient-centered, comprehensive, and accessible complete medical record, an Electronic Personal Health Record (E-PHR) and an E-PHR system and method that permits the patient to control, generate, access, and selectively share their E-PHR as generated from EMRs at multiple healthcare providers. The E-PHR system and method may also permit healthcare providers to share information between one another.

EMRs contain protected PHI, and thus transferring EMRs raises concerns for patient privacy and security. New laws and regulations as well as market forces are beginning to demand more convenient means of electronic communication with healthcare providers while also demanding a high level of security, privacy, and reliability in said electronic communication. Therefore, what is needed is an E-PHR system and method that is able to securely, privately, and reliably transfer PHI information to the patient and to other healthcare providers.

Additionally, while sharing medical information is important, over sharing may result in duplicate, irrelevant, or ignored information. For example, the need to sift through duplicate or irrelevant information may result in healthcare providers choosing not to review, or to simply “skim” over, patients' EMRs rather than review them in detail. Similarly, a healthcare provider would not want to automatically integrate received information with their EMR systems for the foregoing or other reasons. Nor would a patient want to automatically integrate received information with their health records. Therefore, what is needed is an E-PHR system and method that permits the patient and the healthcare provider to preview the transmitted information, select information to be shared, and select received information to be kept and integrated with their records.

Finally, healthcare providers often have long wait times which are in part caused by the need for each patient to fill out a pre-visit questionnaire and other paperwork, which is then transcribed into the patient's EMR. This may cause increased wait time, unnecessary paper files, and potential errors in transcribing those documents. Therefore, what is needed is an E-PHR system that allows the patient to fill out a pre-visit questionnaire and other paperwork prior to their appointment and electronically share that information with their healthcare provider, thereby reducing wait time.

The present invention is an E-PHR system and method where the patient is central to the architecture (i.e., the “hub”) by way of the patient's electronic device. The E-PHR system and method may generate a comprehensive E-PHR by receiving and combining EMRs from all of the patient's healthcare providers. The system and method may further permit the patient to communicate all or parts of his or her E-PHR between all or some of his or her healthcare providers via a software program that is installed on the patient's electronic device and the healthcare providers' electronic device.

The E-PHR application (“app”) may be installed on the patient's electronic device such that the patient's E-PHR is maintained and controlled by the patient. After visiting a healthcare provider, the healthcare provider may transmit the patient's updated EMR to the patient by way of the healthcare provider's app. The patient may receive the EMR and determine what information to stored and what to discard, thereby updating the patient's E-PHR.

Additionally, the patient may send some or all of their E-PHR to the patient's various other healthcare providers. Similarly, the healthcare provider may send some or all of their E-PHR to the patient's various other healthcare providers. Generally, if not always, the healthcare provider will obtain the patient's consent prior to sending the E-PHR or other PHI. Each healthcare provider may be given the opportunity to accept or reject said information. In this way, all healthcare providers are provided with all relevant medical information. For example, but without limitation, the healthcare provider may reject the E-PHR or select items of thereof that are irrelevant, duplicative, or that the provider believes may contain unreliable or inaccurate information.

The E-PHR app may interface with the healthcare provider's existing EMR systems, thereby allowing the healthcare provider to update the patient's E-PHR based on the transmitted EMR or PHI and allowing the patient to share some of all of their updated E-PHR with his or her healthcare providers. This interface may be accomplished by the use of standardized clinical documents such as the Continuity of Care Document (CCD) and the like. These standardized clinical documents may utilize communication and formatting protocols, such as but not limited to, the Clinical Document Architecture (CDA) or Consolidated-CDA (CCDA). The transmission of the standardized clinical documents may be accomplished by the user of Healthcare Information Service Providers (HISPs).

For example, without limitation, the healthcare provider's EMR may be converted to the standardized clinical document using the healthcare provider's E-PHR app. The standardized clinical document may be stored on and transmitted by the healthcare provider's E-PHR application through one or more HISPs to a patient's E-PHR app where it is stored, edited, added to, and/or transmitted to other healthcare providers in the form of the E-PHR. Each patient and healthcare provider may be assigned an identification number or other unique identifier (hereinafter also “ID number”) by the HISP. In exemplary embodiments, both the healthcare provider and the patient are assigned an ID number and a secured email account by the HISP. Each standardized clinical document may also be tagged with one or more ID numbers, such as but not limited to a Provider ID number as well as a document or CCD ID number, to be associated with and/or transmitted to the patient or healthcare provider having the corresponding ID number. The E-PHR may include all kinds of healthcare related data and electronic communications, including but not limited to, medication information, refill requests, appointment scheduling, electronic messaging, allergy information, conditions and diagnoses, lab results, imaging results, and provide a means of importing and exporting such data and communications.

With the described ability to share PHI, the E-PHR app may permit the patient to fill out or auto-populate and transmit their pre-visit questionnaire and other paperwork before their appointment. This reduces waiting time, unnecessary paper files, and potential transcription errors.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is an exemplary method in accordance with the present invention;

FIG. 2 illustrates the various steps of FIG. 1;

FIG. 3 is an exemplary system in accordance with the present invention;

FIG. 4 is another exemplary embodiment of the system of FIG. 3;

FIG. 5 is an exemplary system and patient interface in accordance with the present invention, specifically of the patient interface;

FIG. 6A is another view of the exemplary system of FIG. 5;

FIG. 6B is another view of the exemplary system of FIG. 5;

FIG. 7 is another view of the exemplary system of FIG. 5;

FIG. 8 is another view of the exemplary system of FIG. 5;

FIG. 9A is another view of the exemplary system of FIG. 5;

FIG. 9B is another view of the exemplary system of FIG. 5

FIG. 10A is another view of the exemplary system of FIG. 5;

FIG. 10B is another view of the exemplary system of FIG. 5;

FIG. 11 is another view of the exemplary system of FIG. 5;

FIG. 12 is another view of the exemplary system of FIG. 5;

FIG. 13A is another view of the exemplary system of FIG. 5;

FIG. 13B is another view of the exemplary system of FIG. 5;

FIG. 14A is another view of the exemplary system of FIG. 5;

FIG. 14B is another view of the exemplary system of FIG. 5;

FIG. 15 is another view of the exemplary system of FIG. 5;

FIG. 16 is another view of the exemplary system of FIG. 5;

FIG. 17 is another view of the exemplary system of FIG. 5;

FIG. 18 is another view of the exemplary system of FIG. 5;

FIG. 19 is another view of the exemplary system of FIG. 5, specifically of healthcare provider interface;

FIG. 20A is another view of the exemplary system of FIG. 19;

FIG. 20B is another view of the exemplary system of FIG. 19;

FIG. 21A is another view of the exemplary system of FIG. 19;

FIG. 21B is another view of the exemplary system of FIG. 19;

FIG. 22 is another view of the exemplary system of FIG. 19;

FIG. 23 is another view of the exemplary system of FIG. 19;

FIG. 24 is another view of the exemplary system of FIG. 19;

FIG. 25A is another view of the exemplary system of FIG. 19;

FIG. 25B is another view of the exemplary system of FIG. 19;

FIG. 25C is another view of the exemplary system of FIG. 19;

FIG. 25D is another view of the exemplary system of FIG. 19;

FIG. 25E is another view of the exemplary system of FIG. 19;

FIG. 26 is another view of the exemplary system of FIG. 5, specifically of an administration interface for the healthcare provider's practice;

FIG. 27 illustrates another exemplary system in accordance with the present invention;

FIG. 28 illustrates another exemplary system in accordance with the present invention;

FIG. 29 illustrates another exemplary system in accordance with the present invention;

FIG. 30 illustrates another exemplary system in accordance with the present invention;

FIG. 31 illustrates another exemplary system in accordance with the present invention;

FIG. 32 is an exemplary method in accordance with the present invention;

FIG. 33 is an exemplary registration and vetting system in accordance with the present invention;

FIG. 34 is an exemplary structure for a Clinical Document Architecture (“CDA”) for use with the system and methods of the present invention;

FIG. 35 illustrates another exemplary system in accordance with the present invention;

FIG. 36 is an exemplary method for use with at least the system of FIG. 35; and

FIG. 37 is another exemplary method for use with at least the system of FIG. 35.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

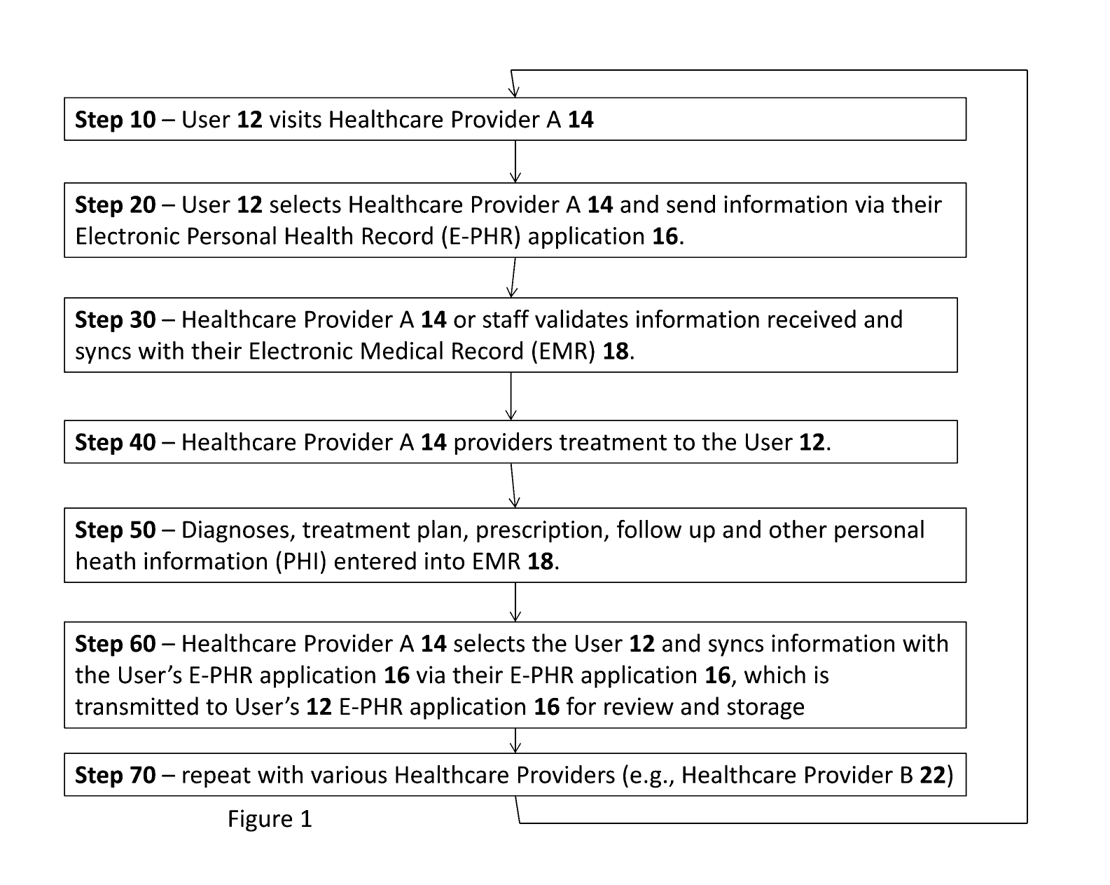

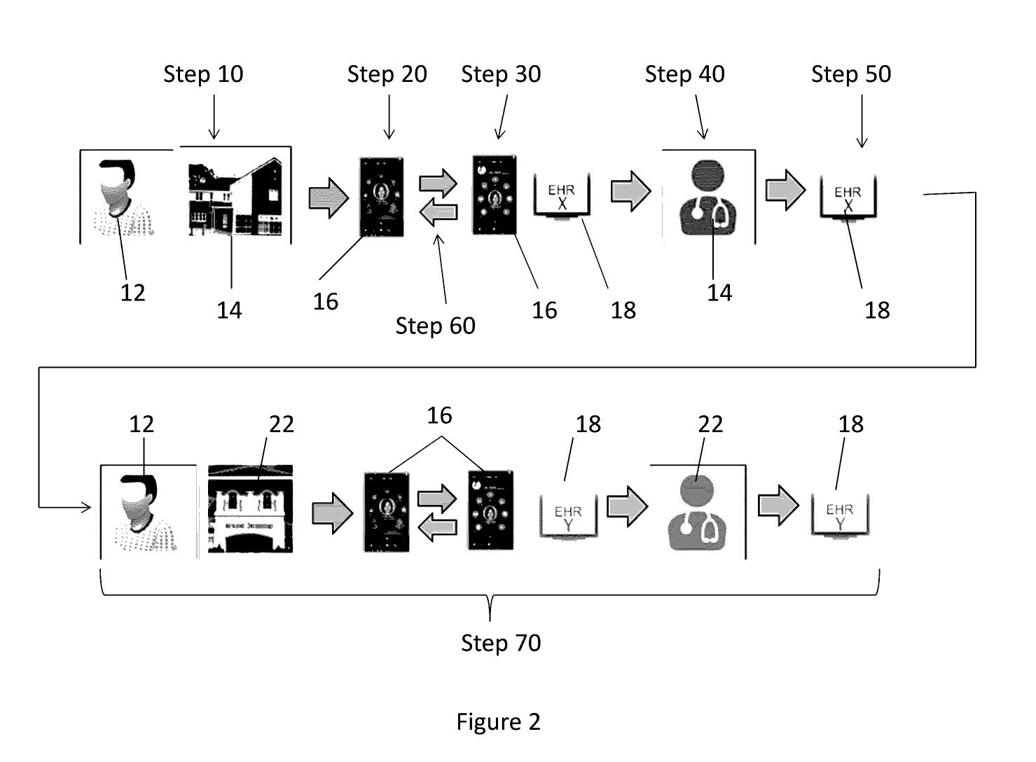

FIG. 1 describes an exemplary method where said method is also illustrated in FIG. 2. In Step 10 a patient 12 visits a Healthcare Provider A 14. Next, in Step 20, the patient 12 selects Healthcare Provider A 14 on their E-PHR application 16 (hereinafter also the “app” or the “E-PHR app”). The app 16 may be installed on a smart phone or other electronic device, including but not limited to, a tablet, desktop computer, laptop computer, or the like. More specific examples include, but are not limited to, the iPhone, Android phones, iPad, Kindle, Nook, Android tablets, Mac Book, windows based laptops, desktop computers, other electronic devices, and the like.

Next the patient 12 may select some or all of their E-PHR to send to the Healthcare Provider A 14 via the E-PHR app 16. It is notable that the term “Healthcare Provider” is used broadly and inclusively herein to refer to the medical, clerical, office staff, or other employees, contractors, associates, organizations, or other persons associated with the Healthcare Provider and otherwise involved with the medical treatment of the patient. In Step 30, the Healthcare Provider A 14, who also has installed the app 16 on their electronic device, selects what of the received information to keep and what to ignore. The Healthcare Provider A 14 may sync the selected E-PHR information with their EMR system 18. This may be accomplished by the use of a standardized clinical document such as, but not limited to, the CCD. A person having skill in the art will recognize that the CCD is merely exemplary and any currently known or future developed standardized clinical documents may be utilized with the present invention.

The CCD may be created by use of a communication and formatting protocol such as, but not limited to, the CDA, CCDA, or the like. The CCDA, CDA, or the like is any base standard that provides a common architecture, coding, semantic framework, and markup language for the creation of electronic clinical documents such as, but not limited to, the CCD. In exemplary embodiments of the present invention, the standardized clinical document, may be human readable, templated, object oriented, coded via standard vocabulary, use standardized expressions of clinical concepts, and provide meaningful use of data requirements. The standardized clinical document may comprise some or all of the following standard sections, without limitation: patient demographics, advance directives, insurance payers, healthcare providers, family history, social history, encounters, conditions or problems, medications, allergies, vital signs, diagnostic results, immunizations, procedures, and the like. In exemplary embodiments, the communication and formatting protocol may be coded in Extensible Markup Language (XML) but such is not required. A person having skill in the art will recognize that the CDA and CCDA is merely exemplary and any currently known or future developed communication and formatting protocols may be utilized with the present invention.

The standardized clinical document may be received by the healthcare provider's E-PHR application 16 and integrated into their EMR system 18. Next, in Step 40, the Healthcare Provider A 14 provides the treatment to the patient 12. In Step 50, the patient's diagnoses, treatment plan, prescription, follow up plan, other PHI, and other information may be entered by the Healthcare Provider A 14 or their staff into the patient's EMR 18. In Step 60, the Healthcare Provider A 14 or their staff may select the patient 12 via the healthcare provider's E-PHR application 16 and sync the new PHI and other information from the patient's appointment from the patient's EMR 18 with the patient's E-PHR application 16. As previously discussed, this may be accomplished by way of the standardized clinical document such as, but not limited to, the CCD. The healthcare provider's E-PHR application 16 may convert the patient's EMR 18, PHI, or other information into the standardized clinical document. The standardized clinical document may be tagged with an ID number, such as but not limited to, a document ID number, the patient's ID number, the healthcare provider's ID number, and other recipient's ID numbers, and may then be communicated by way of the HISP. In exemplary embodiments, the HISP may assign and tag the appropriate ID numbers and communication of the standardized clinical document may take place by way of the secured email accounts assigned to the patient and the healthcare provider by the HISP. The standardized clinical document may then be received, translated, and merged with the patient's E-PHR and/or other PHI and information to create a complete E-PHR stored on the patient's E-PHR application 16. The patient 12 may then review the information and select what to keep and what to ignore. This information is made available to the patient 12 via the patient's E-PHR application 16 on the patient's electronic device. The process may be repeated, as detailed in Step 70, with various healthcare providers, such as healthcare provider B 22.

For example, without limitation, as best illustrated in FIG. 2, Step 10 through Step 60 may be completed with the patient 12 and the Healthcare Provider A 14, who has a particular EMR system 18, represented in the present figures as “EHR X.” The process may be repeated at Step 70 with the patient 12 and Healthcare Provider B 22 who may have a different EMR system 18, represented in the present figures as “EHR Y.” For example, without limitation, Healthcare Provider A 14 may be a general practitioner, who the patient sees about a sinus infection and Healthcare Provider B 22 may be a dermatologist, who the patient sees about an eczema condition. These examples are not intended to be limiting, the present method may be repeated and applied to any number of healthcare providers for any number of specialties, practices, conditions, treatments, and the like.

The PHI and E-PHR information may be stored locally on the patient's or healthcare provider's electronic device or it may be stored remotely such as on a networked database or the like and accessed by the E-PHR application 112. In exemplary embodiments of the present invention, each of the personal electronic devices and EMR systems are connected to a communications network, such as but not limited to, the internet to access the relevant information stored on networked databases.

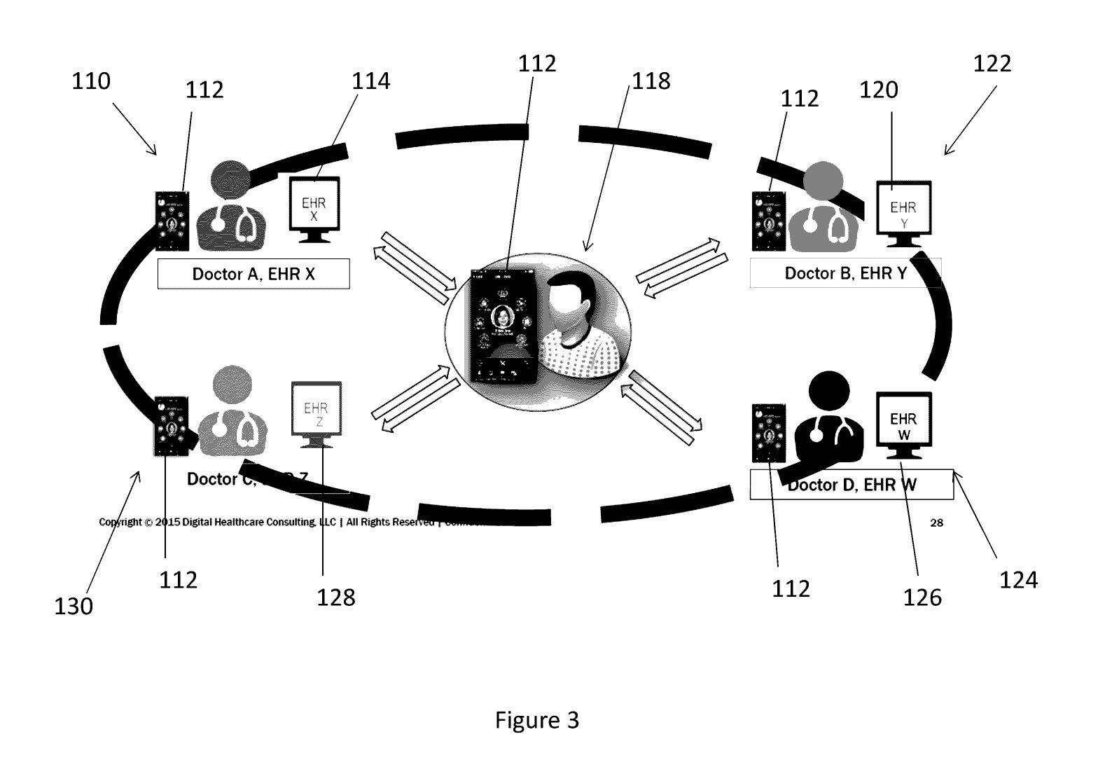

FIG. 3 illustrates an exemplary system in accordance with the present invention. Each healthcare provider, 110, 122, 124, and 130, may have a different EMR system, 114, 120, 126, and 128. In other exemplary embodiments, one or more of the healthcare providers 110, 120, 130, and 136 may have the same EMR system. The present system may work with any number of healthcare providers. In exemplary embodiments of the present invention, each healthcare provider 110, 122, 124, and 130 has the E-PHR app 112, however such is not required. Each of the healthcare providers 110, 122, 124, and 130 may utilize the method illustrated in FIG. 1 and FIG. 2 to communicate the patient's EMR, PHI, or other information to the patient 118 and between the various healthcare providers 110, 122, 124, and 130 to generate an E-PHR. As will be explained in greater detail in subsequent figures, the patient 118 may choose what parts of their E-PHR to send to what healthcare providers 110, 122, 124, and 130 and likewise the healthcare providers 110, 122, 124, and 130 may choose what portions of the patient's 118 E-PHR to share with other healthcare providers 110, 122, 124, and 130. Further still, the patient 118 and the healthcare providers 110, 122, 124, and 130 receiving the E-PHR or other information may choose what information to accept and store in the patient's 118 E-PHR.

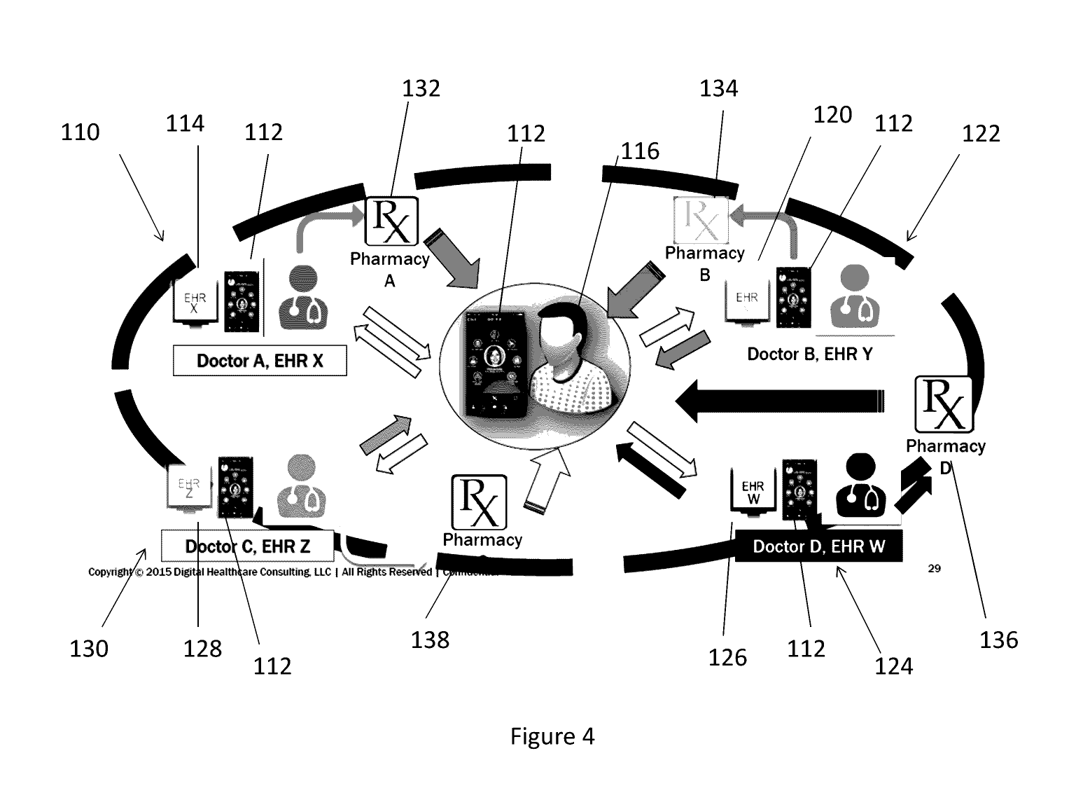

FIG. 4 illustrates the system of FIG. 3 and additionally illustrates how each of the healthcare providers 110, 122, 134, and 130 may communicate prescription related PHI via the E-PHR application 112 to various pharmaceutical providers 132, 134, 136, 138 through the E-PHR app 112 and an interface with the pharmaceutical providers 132, 134, 136, 138. This information may include, but is not limited to, the patient's 116 name, date of birth, other identifying information, prescription information, dosage information, refill information, known drug allergies, insurance information, and the like. In exemplary embodiments of the present invention, each of the pharmaceutical providers 132, 134, 136, 138 may likewise have the E-PHR application 112 installed on their electronic device, though such is not required. The pharmaceutical providers 132, 134, 136, 138 may provide the prescription to the patient 116 and may communicate the appropriate prescription related PHI via the E-PHR application 112 to the patient 116.

If the pharmaceutical providers 132, 134, 136, 138 do not have or use the E-PHR application 112, the pharmaceutical providers 132, 134, 136, 138 may instead communicate the appropriate prescription related PHI to the healthcare provider's EMR system 114, 120, 126, 128, which may then transmit the prescription related PHI to the patient 116 in the same way other PHI is transmitted as described herein. Likewise, the healthcare providers 110, 122, 124, 130 may communicate prescription related PHI and other information via the EMR systems 114, 120, 126, 128. Such information may include, but is not limited to, the patient's 116 name, date of birth, other identifying information, prescription information, dosage information, instructions, side effects, drug information, refill information, known drug allergies, insurance information, and the like. This information may also include the pharmaceutical providers' 132, 134, 136, 138 address, phone number, other contact information, the prescription number, refill information, pharmacy hours, prescription pick up time, and the like.

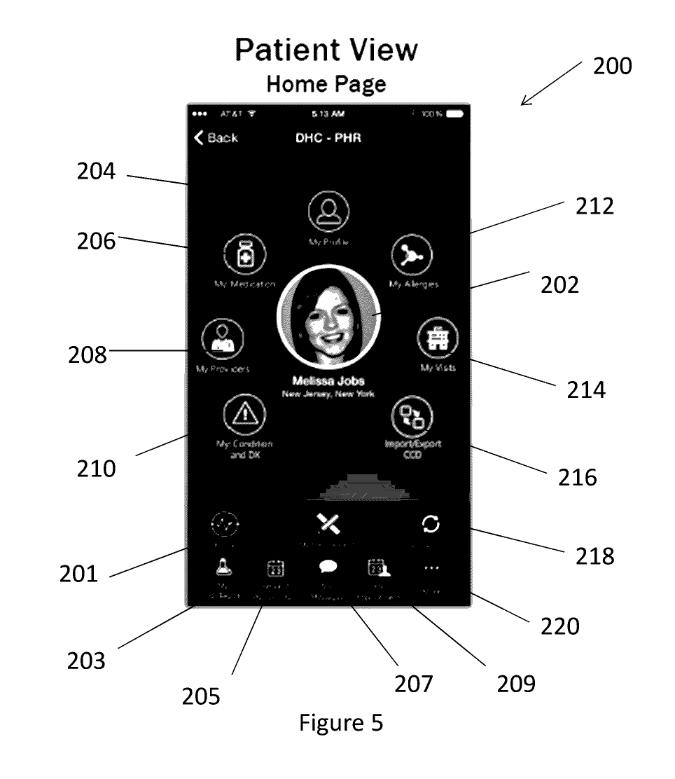

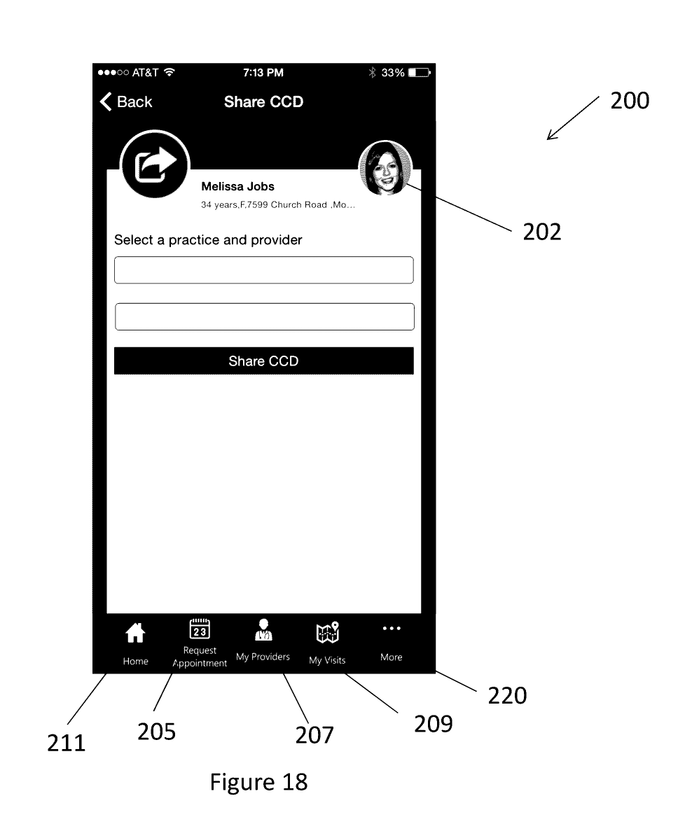

FIG. 5 though FIG. 18 illustrates an exemplary embodiment of the E-PHR application 200 in accordance with the present invention, specifically of the patient interface as seen by the patient 202. FIG. 5 illustrates an exemplary home page for the E-PHR application 200. This may be the default screen the patient 202 observes upon opening the E-PHR application 200. A new user or a logged out user may instead first see a login and registration page.

The home page of the E-PHR application 200 may include a picture of the patient 202, and links to the patient's 202 profile 204, medications 206, providers 208, conditions and diagnoses 210, allergies 212, visits 214, vitals 201, lab results 203, appointment requests 205, messages 207, appointments 209, sync device data 218, import/export features 216, and a link to additional options 220. While the present figure illustrates these icons arranged in a fanned pattern around an image of the patient 202 with two rows or additional links thereunder, it is contemplated that these icons may be arranged in any pattern. Further still, these icons may be arranged by the user to their liking. As will be illustrated in other figures herein, additional icons not shown in FIG. 5 may be present on this or other screens such as, but not limited to, home 211, my medical history 213, personal contacts 215, emergency contact 217, insurance details 219, demographics 221, immunizations 223, and the like. Each screen may provide different icons and/or different arrangement of icons. Each of the icons may be linked to different interfaces of the E-PHR app 16 displaying various data sets and options to the patient 202.

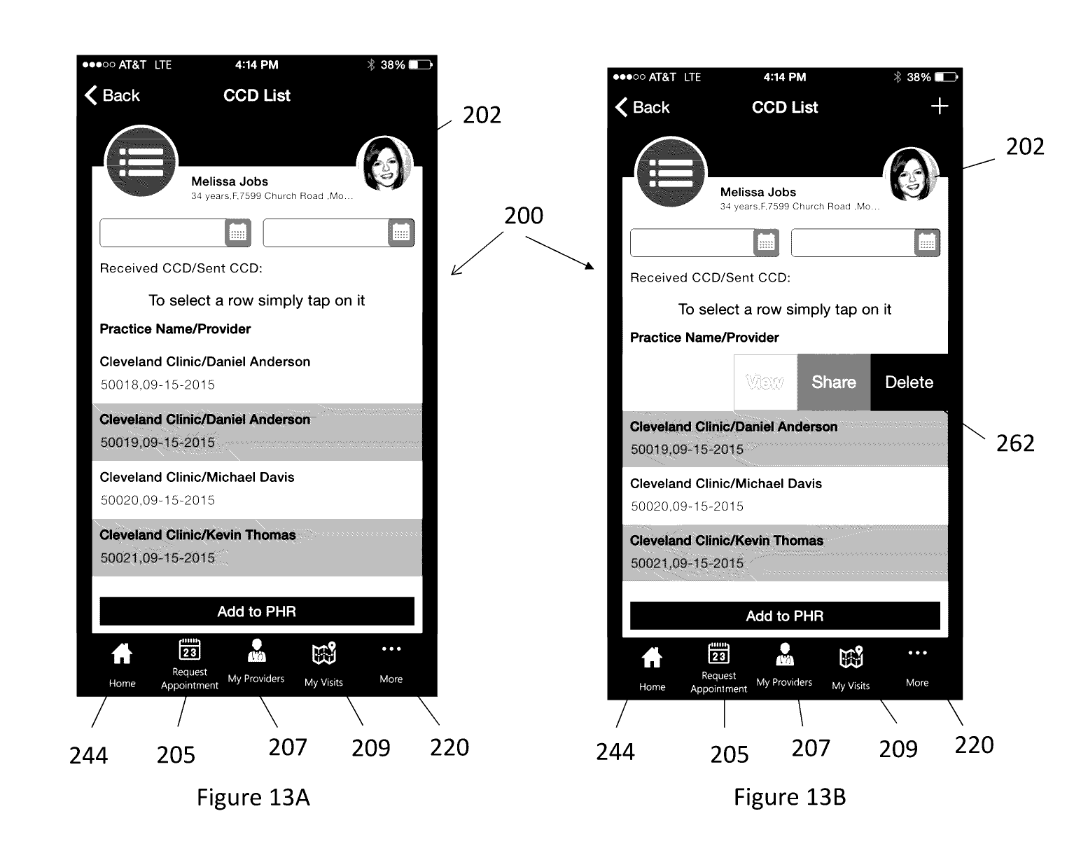

The import/export option 216 may allow the patient 202 to communicate some or all of their E-PHR to or from a healthcare provider 222. As will be explained in greater detail, particularly in FIG. 13 through FIG. 15, the import/export 216 feature may be accomplished by using a standardized clinical document, such as but not limited to the CCD. The import/export 216 may be carried out by the HISP and may be accomplished using various security and privacy protocols, including but not limited to, DirectTrust and DirectTrust certified members (https://www.directtrust.org).

The HISPs may be information exchange mediums that may provide security and privacy protocols for the exchange and communication of PHI, E-PHRs, messages, emails, and other related data and communications. In exemplary embodiments, the HISP may provide assurance, security, and standards for secure communications. One example of an acceptable HISP is UPDOX (https://www.updox.com/solutions/direct) or other members of DirectTrust. A person having skill in the art will understand that any information exchange mediums and other security and privacy protocols currently known or developed in the future may be utilized with the present invention.

The import/export 216 may additionally permit the healthcare provider 222 to communicate a pre-visit questionnaire and other paperwork to the patient 202 in advance of the patient's 202 appointment. In exemplary embodiments, the app 16 may have a separate page, tab, section, or the like for modifying, managing, and transmitting the pre-visit questionnaire and other paperwork. Likewise, the import/export 216 may permit the patient 202 to send the healthcare provider 222 their relevant E-PHR information needed to complete a pre-visit questionnaire and other paperwork in advance. In an exemplary embodiment of the present invention, the healthcare provider 222 may provide an electronic version of the pre-visit questionnaire and other paperwork which the patient 202 completes and sends back electronically by way of the app 16. In another exemplary embodiment, the pre-visit questionnaire and other paperwork may be auto populated by the app 16 based on the patient's 202 E-PHR. Regardless, this may reduce waiting room times, unnecessary paper files, and potential errors in transcribing the paper questionnaires and paperwork into the patient's 202 to EMR.

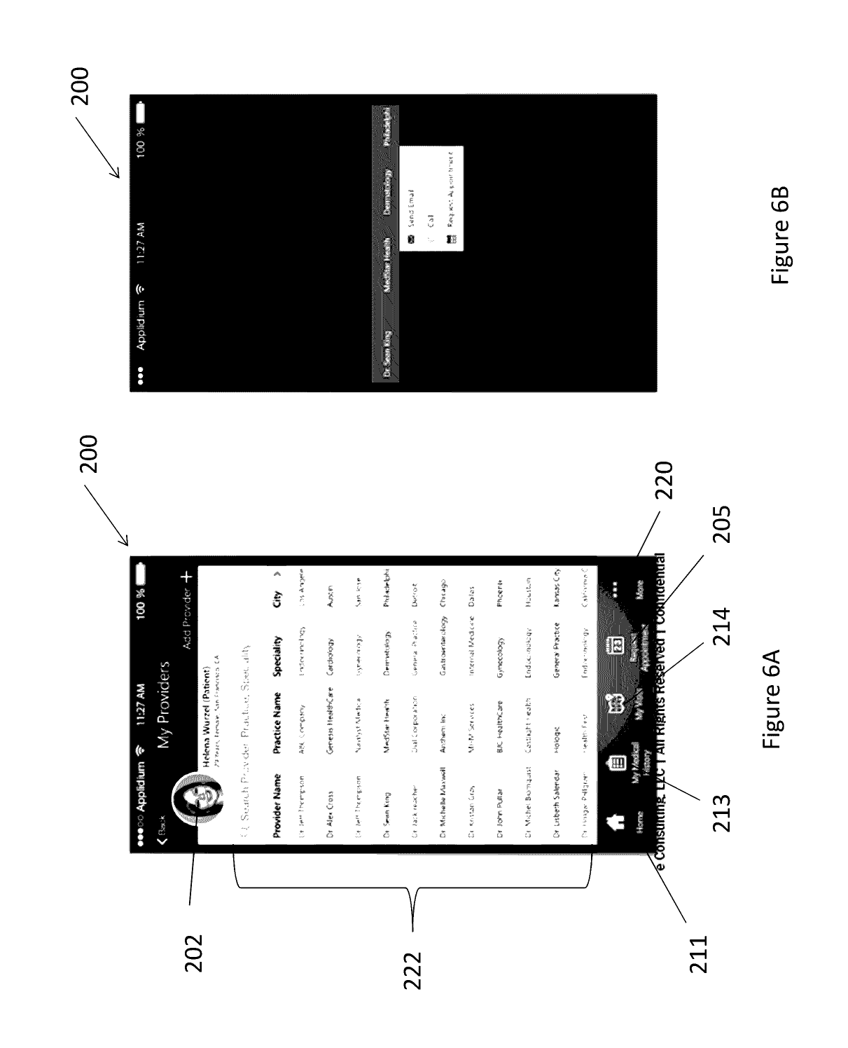

FIG. 6A and FIG. 6B illustrates an exemplary my providers 208 interface. A list of the patient's 202 healthcare providers 222 is displayed. A particular healthcare provider 222 may be selected, which may present the patient 202 with links to email, call, or request an appointment with said healthcare provider 222. These options are merely exemplary and not intended to be limiting.

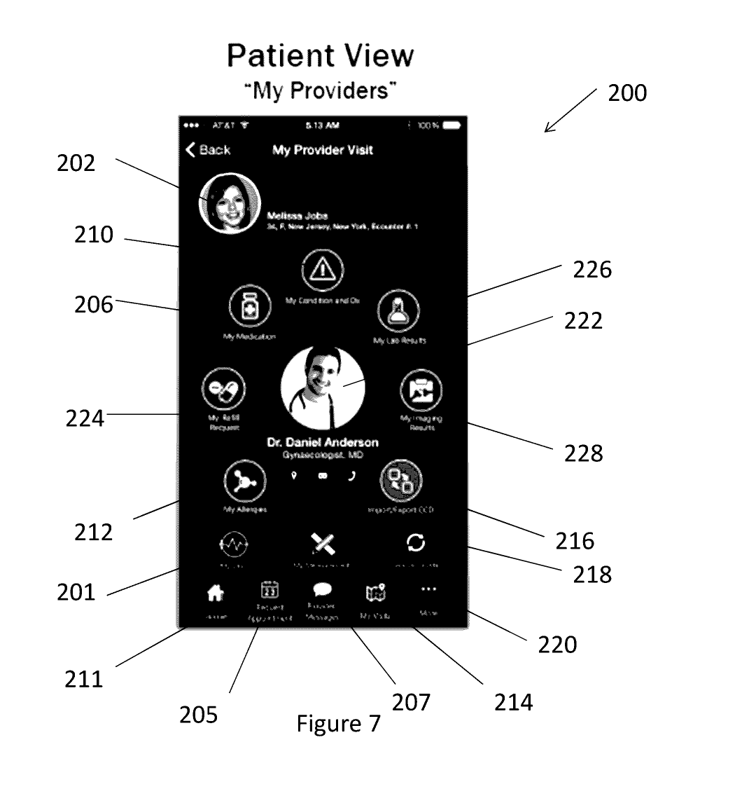

FIG. 7 illustrates an exemplary interface for the E-PHR application 200 when a particular healthcare provider 222 is selected from the list of providers illustrated in FIG. 6A and FIG. 6B. Similar to FIG. 5, a series of icons may appear around the selected healthcare provider 222. The healthcare provider's 222 contact information may appear below their photo. The icons may include the patient's 202 conditions and diagnoses 210, medications 206, allergies 212, and import/export options 216, similar to FIG. 5, except that in the present screen they may be specific to those related to the selected healthcare provider 222. Additionally, icons related to refill requests 224, lab results 226, and imaging results 228 may be present.

These icons may be spaced around a photo of the healthcare provider 222 in an arc, though any shape or arrangement of the links is contemplated. Other examples of possible icons providing links to other patient 202 and healthcare provider 222 interfaces include, but are not limited to, patient demographics, advance directives, insurance payers, healthcare providers, family history, social history, encounters, conditions or problems, medications, allergies, vital signs, diagnostic results, immunizations, and procedures. Again, this list is merely exemplary and is not intended to be limiting, any healthcare related information is contemplated.

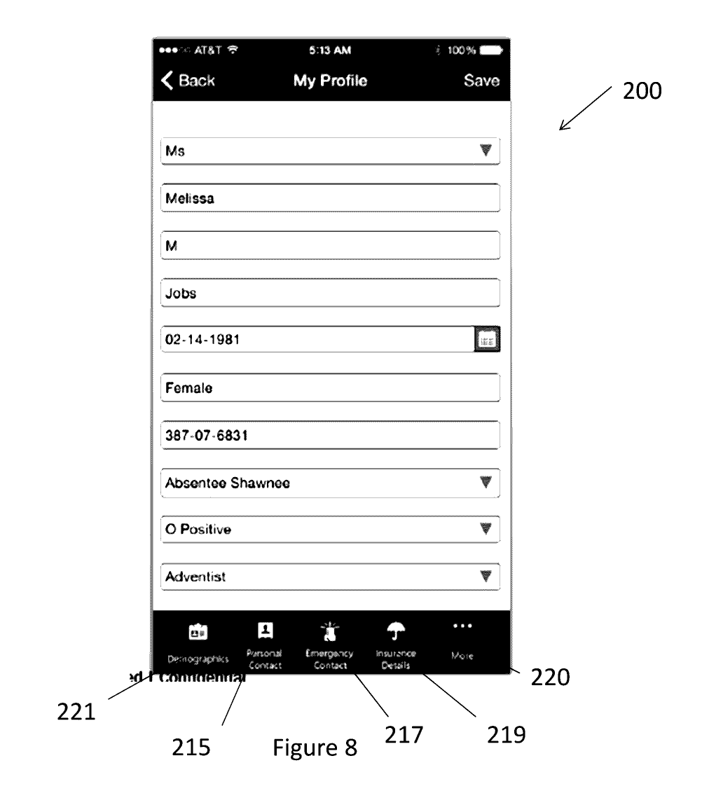

FIG. 8 illustrates an exemplary my profile 204 interface. The my profile 204 interface may include editable fields of various identifying information about the patient 202 including name, date of birth, gender, contact information, and other relevant information. Any type of identifying or otherwise relevant information is contemplated.

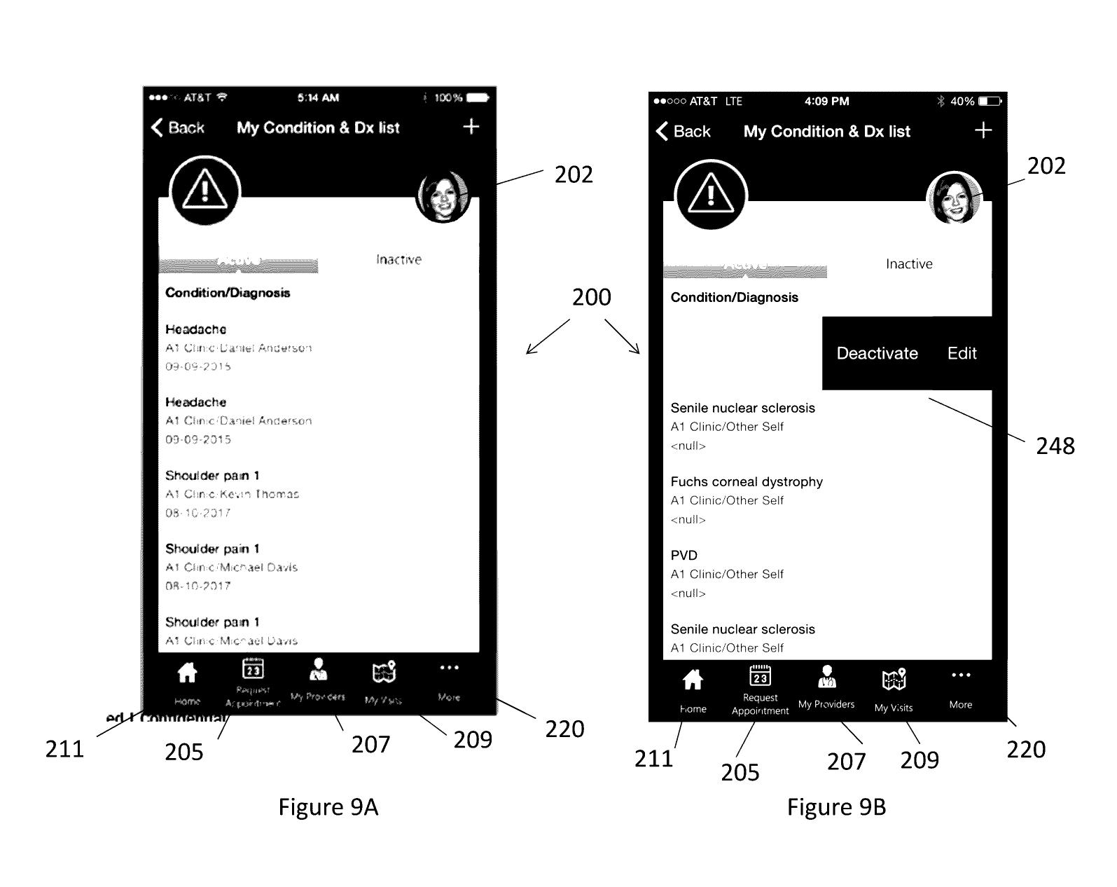

FIG. 9A and FIG. 9B illustrates an exemplary my conditions and diagnoses 210 interface. This interface may include the type and details of each condition and diagnoses. This information may include all conditions and diagnoses for the particular patient 202, or may be sorted by the conditions and diagnoses received from a particular healthcare provider 222. Additionally, the conditions and diagnoses may be sorted by active and inactive conditions and diagnoses.

As best illustrated in FIG. 9B a deactivate/edit button 248 may be exposed by an action such as swiping in any or a particular direction, double tapping, single tapping, or the like, a particular condition or diagnosis. In other exemplary embodiments of the present invention, the deactivate/edit button 248 may be always visible. The deactivate/edit options are merely exemplary; other relevant options may be made available to the user.

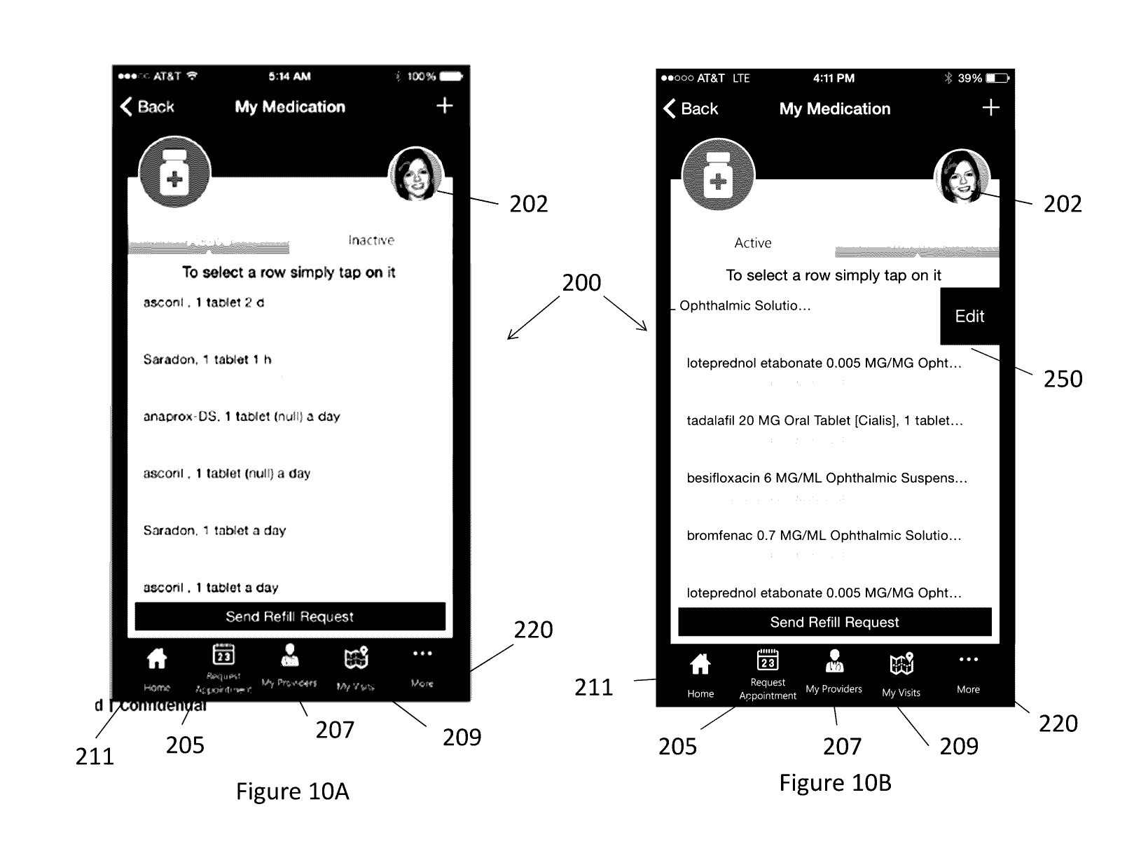

FIG. 10A and FIG. 10B illustrates an exemplary my medications 206 interface. This interface may include the type and details of each medication prescribed, including over the counter drugs. This information may include dosage and refill information. The information may include all medications currently prescribed to the patient 202, or may include only those prescribed by a particular healthcare provider 222. Additionally, the medications may be sorted by active and inactive prescriptions.

As best illustrated in FIG. 10B an activate/edit button 250 may be exposed by an action such as swiping in any or a particular direction, double tapping, single tapping, or the like, a particular medication. In other exemplary embodiments of the present invention, the activate/edit button 250 may be always visible. The deactivate/edit options are merely exemplary; other relevant options may be made available to the user.

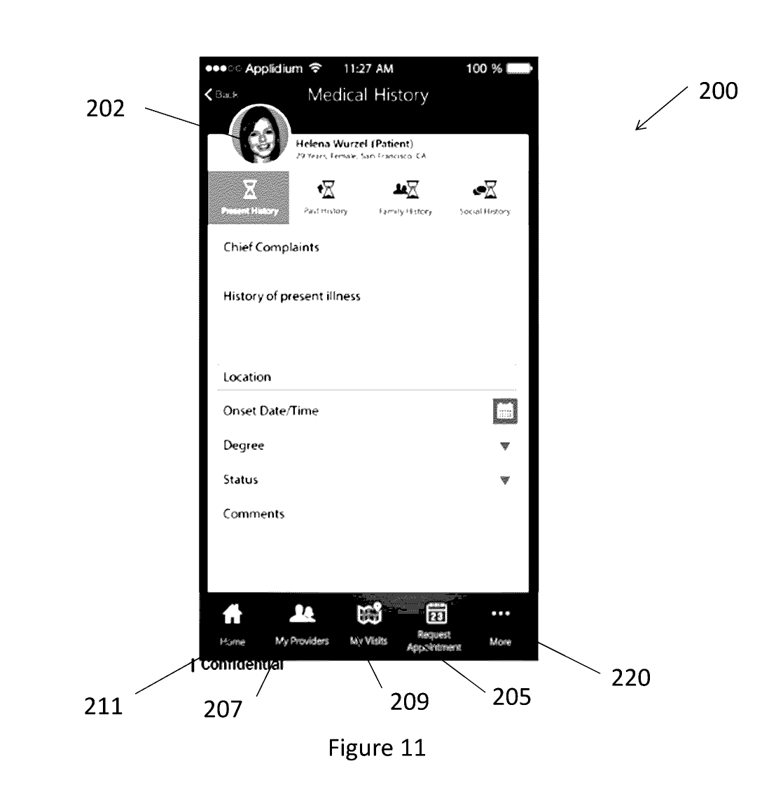

FIG. 11 illustrates an exemplary my medical history 213 interface. This interface may include a present history, past history, family history, social history, and the like. Each issue may be listed with a chief complaint, a history, and include location, date, degree, and status information along with other comments.

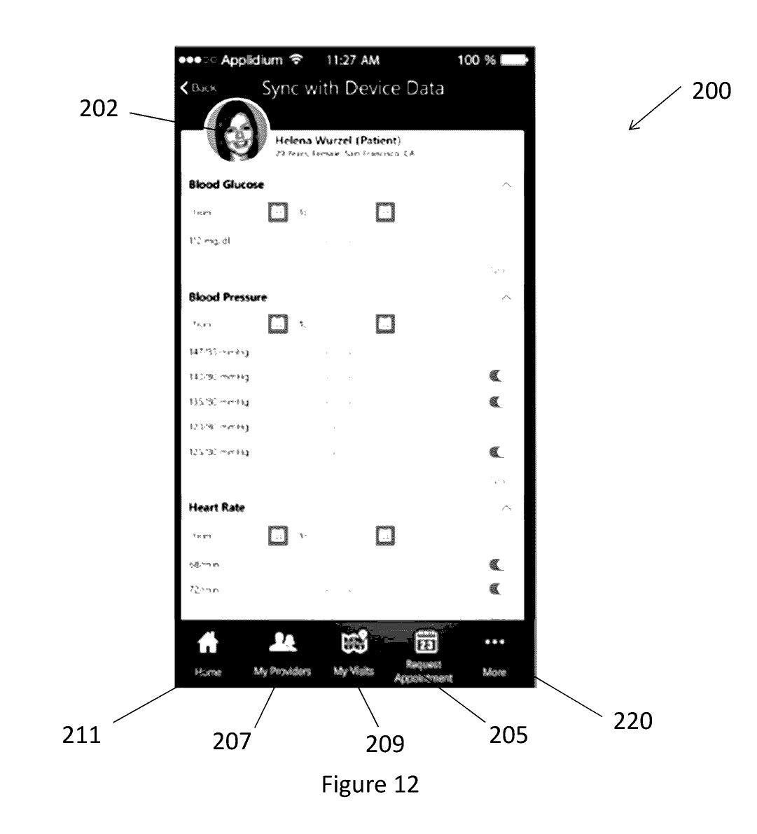

FIG. 12 illustrates a sync with device data 218 interface. The app 200 may communicate with a variety of health and fitness monitoring devices. Such devices may include, but are not limited to, the iWatch, Fitbit, Garmin Forerunner, Nike FuelBand, and any other fitness, health, or wellness tracker. Further still, the app 200 may communicate with digital sensors. These digital sensors may be implantable medical devices such as heart rate monitors, insulin monitors, or any other internal or external medical or wellness sensor. Communication may be accomplished by a wired or wireless connection, such as through USB, Ethernet, the internet, Bluetooth, or the like. Additionally, the app 200 may be in communication with other applications on the patient's 202 electronic device including, but not limited to, the Apple Health, weight Watchers®, or other nutrition and/or activity and/or sleep pattern and/or health and wellness tracking applications and devices. This list is merely exemplary, communication with any application and/or device is contemplated.

This information may be synced with the app 200 and made a part of the patient's 202 E-PHR, which as previously discussed may be transmitted to various healthcare providers 222. The sync with data device link may capture a variety of health related information including, without limitation, blood glucose, blood pressure, and heart rate, caloric intake, exercise history, and the like, though any relevant health information is contemplated. The information logged may include a corresponding time, date, location, or other relevant information. As with the other E-PHR information, the patient 202 may selectively choose what information to record and what information to share with their various healthcare providers 222 and, likewise, the healthcare providers 222 may selectively choose what information to store in the patient's 202 EMR and share with other healthcare providers 222.

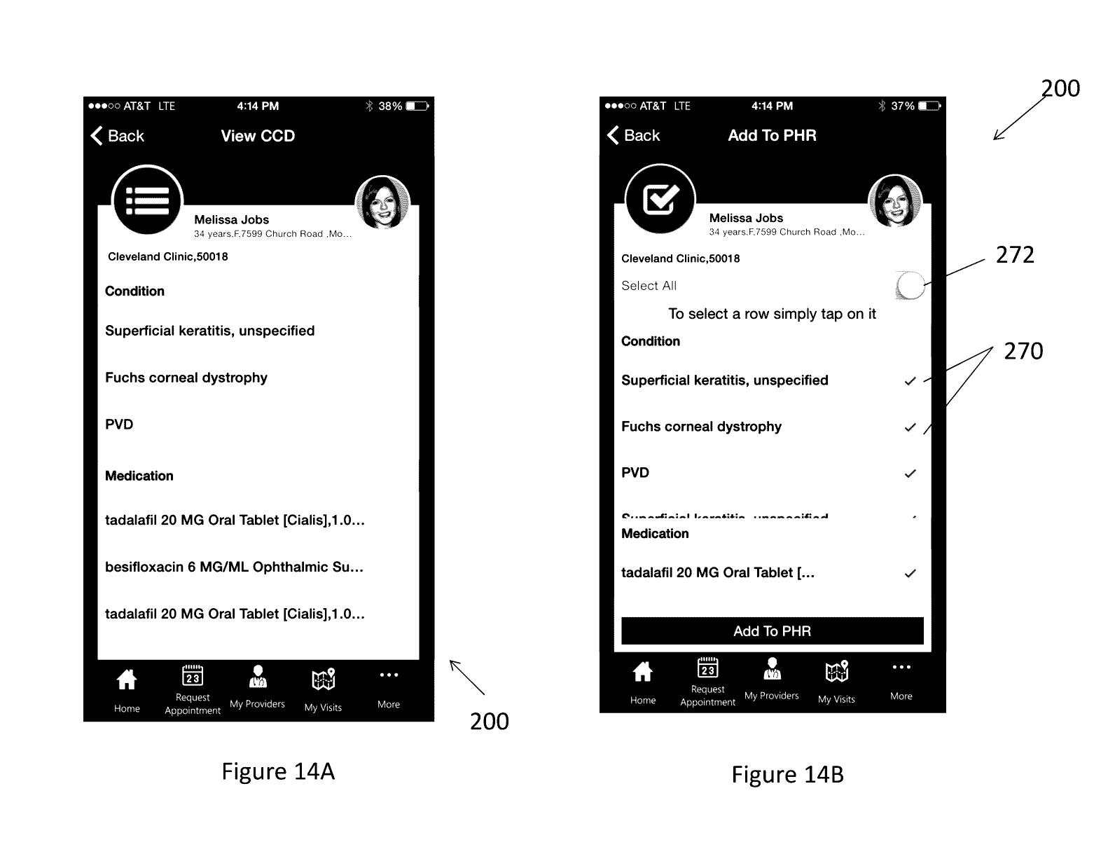

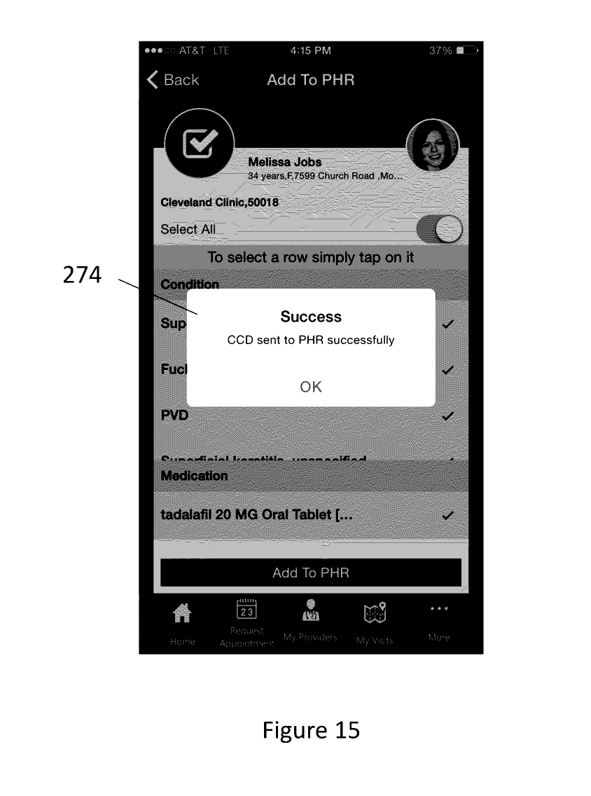

FIG. 13 through FIG. 18 illustrates an exemplary import/export 216 interface and process. As best illustrated in FIG. 13A through FIG. 15 the patient 202 may review and merge a transmitted standardized clinical document with the patient's 202 E-PHR. The patient 202 may select one of various received standardized clinical documents for review. The patient 202 may swipe, tap, click, or otherwise select the standardized clinical document from a list of received documents. In exemplary embodiments, once selected, a list of options 262 is displayed such as view, share, delete, and the like. Upon selecting share or a similar option, as best illustrated in FIGS. 14A and 14B, the standardized clinical document may be displayed. As best illustrated in FIG. 14B, some or all of the standardized clinical document may be selected by the patient 202 to be merged with the patient's 202 E-PHR. User selections may be reflected by indicia 270 such as, but not limited to, check marks, highlights, dots, some combination thereof, or the like. A select all option 272 may be available. As best illustrated in FIG. 15, upon successful merger, a confirmation message 274 may be displayed.

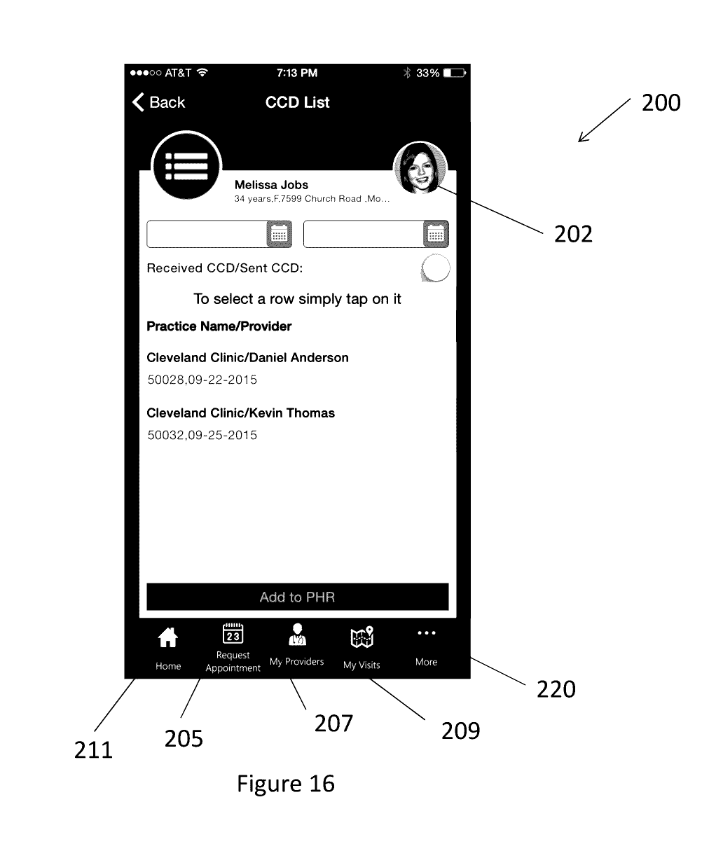

As best illustrated in FIG. 16 through FIG. 18, the patient 202 may share some or all of his or her E-PHR with various healthcare providers 222. In exemplary embodiments, the patient 202 may select from a list of healthcare provider's 222 already associated with the patient's 202 E-PHR app 200. If the healthcare provider 222 is not already so associated, as best illustrated in FIG. 18, the patient 202 may search for and select the healthcare provider 222. Additionally, the patient 202 may edit the list of healthcare providers 222 or add new healthcare providers 222 to the list.

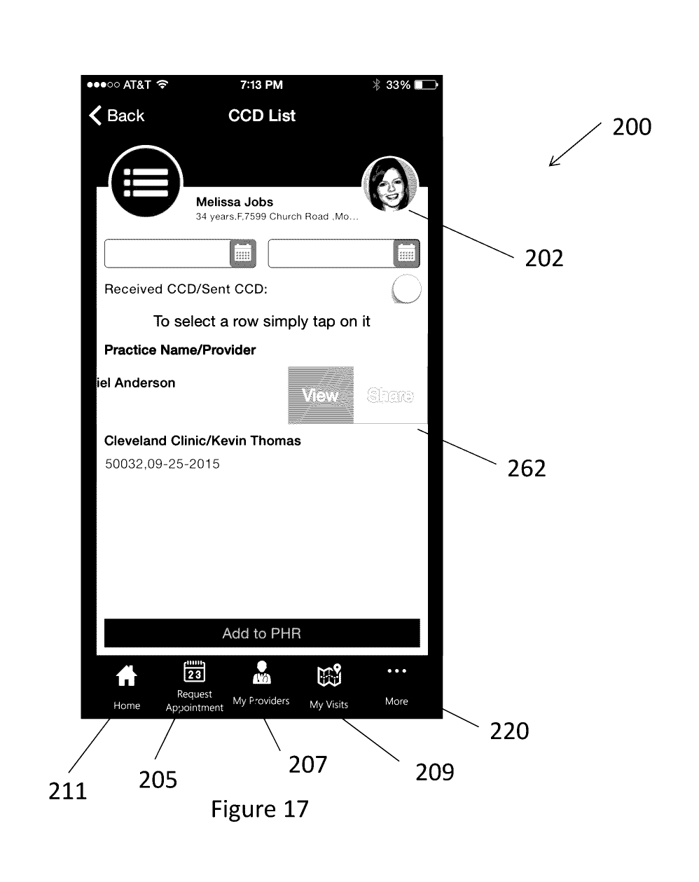

As best illustrated in FIG. 17, after selecting the appropriate healthcare provider 222, a view, share, delete, and other options 262 may be presented by an action such as swiping in any or a particular direction, double tapping, single tapping, or the like. In other exemplary embodiments of the present invention, the view, share, delete, and other options 262 may always be visible. The view, share, and delete options 262 are merely exemplary, other relevant options are contemplated.

Upon selecting share or a similar option, the patient's 202 PHR may be displayed and some or all of the PHR may be selected by the patient 202 for transmission. A select all option 272 may be available. Upon successful transmission, a confirmation message may be displayed.

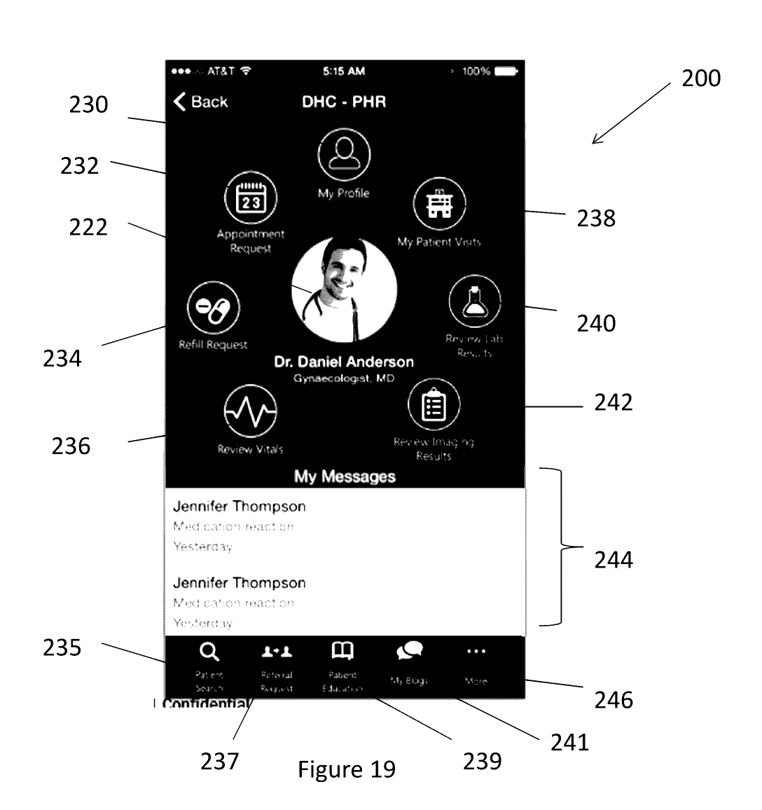

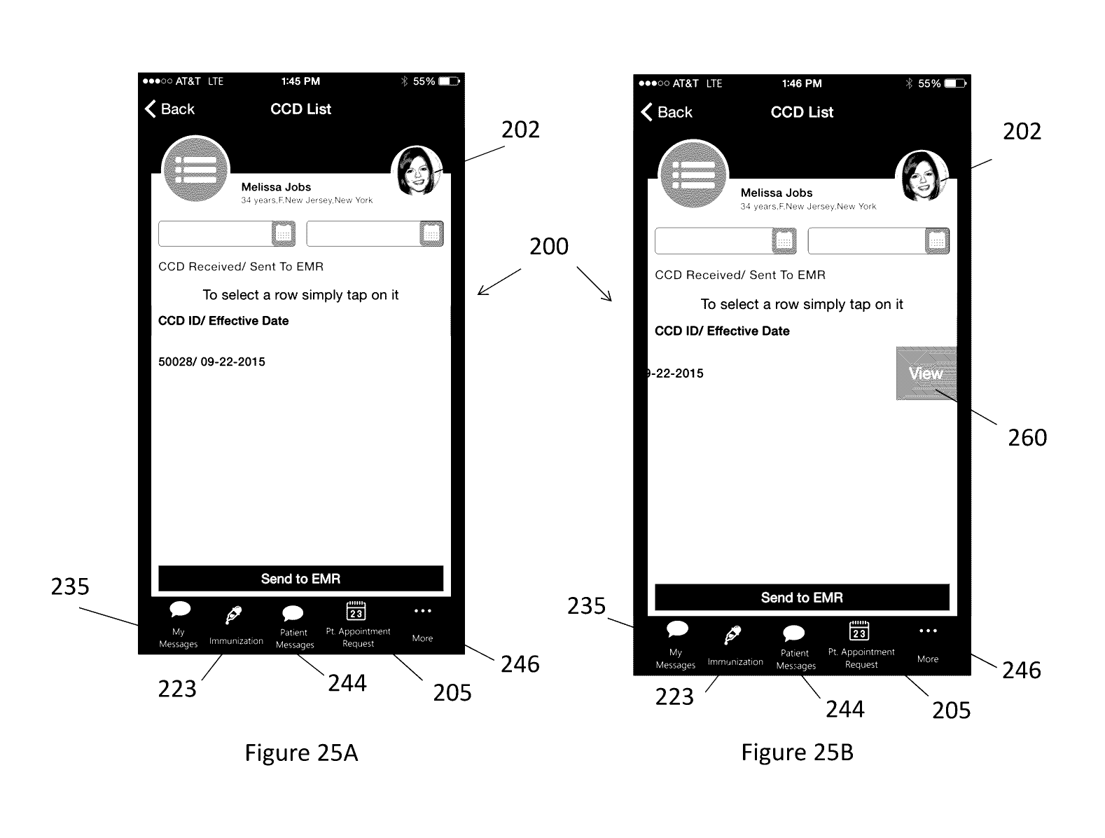

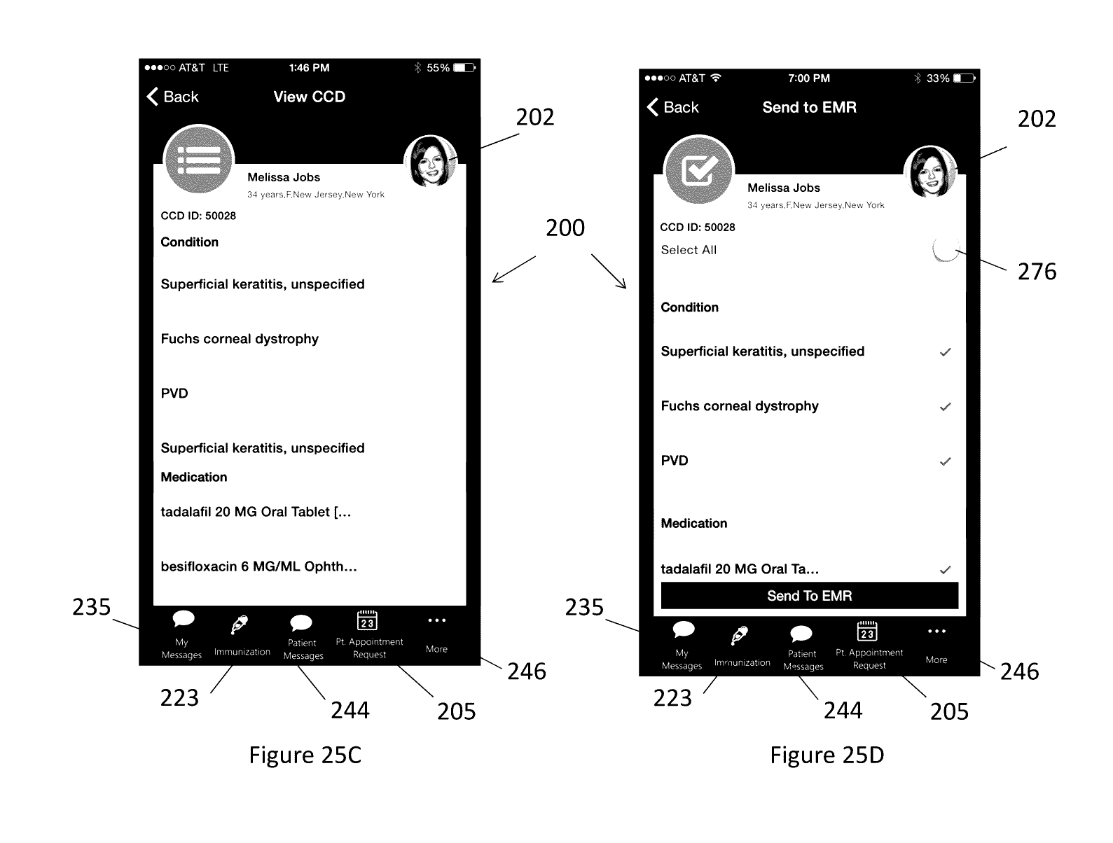

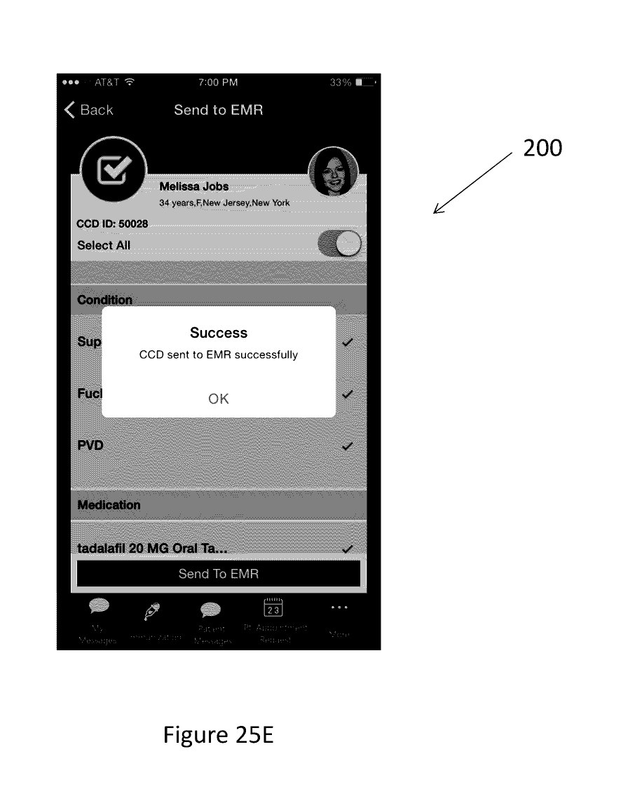

FIG. 19 though FIG. 25E illustrates an exemplary embodiment of the E-PHR application 200 in accordance with the present invention, specifically of an exemplary healthcare provider 222 interface. FIG. 19 illustrates a home page of the E-PHR application 200 as would be viewed by the healthcare provider 222. This may be the default screen the healthcare provider 222 would observe upon opening the E-PHR application 200. A new user or a logged out user may instead first see a login and registration page.

The home page of the E-PHR application 200 may include a series of icon comprising links to various interfaces such as, for example but without limitation, the healthcare provider's 222 profile 230, appointment requests 232, refill requests 234, review patient vitals 236, patient visits 238, review lab results 240, and review imaging results 242. These icons may be arranged in a fanned pattern around an image of the healthcare provider 222, though any arrangement in contemplated. Additionally, a list of messages 244 may be displayed below said links. A bottom row may provide the healthcare provider with links for additional icons including patient search 235, referral requested 237, patient education 239, blogs 241, and a link to more options 246. One having skill in the arts will recognize that these icons and interfaces are merely exemplary and are not intended to be limiting. The same or different icons may be arranged in any way and may be arranged or comprised of different icons on different interfaces of the E-PHR app 200.

PHI gathered by the healthcare provider 222 during a patient's 202 visit may be entered by the healthcare provider 222 or their staff into the healthcare provider's 222 E-PHR app 200. Alternatively, the new PHI may be imported from the healthcare provider's 222 EMR system. For example, but without limitation, the healthcare provider's 222 staff may transcribe handwritten notes from the patient's chart into the EMR system. As previously discussed, the EMR information may be transmitted to the healthcare provider's 222 E-PHR app 200 and transmitted to the patient's 202 E-PHR app 200.

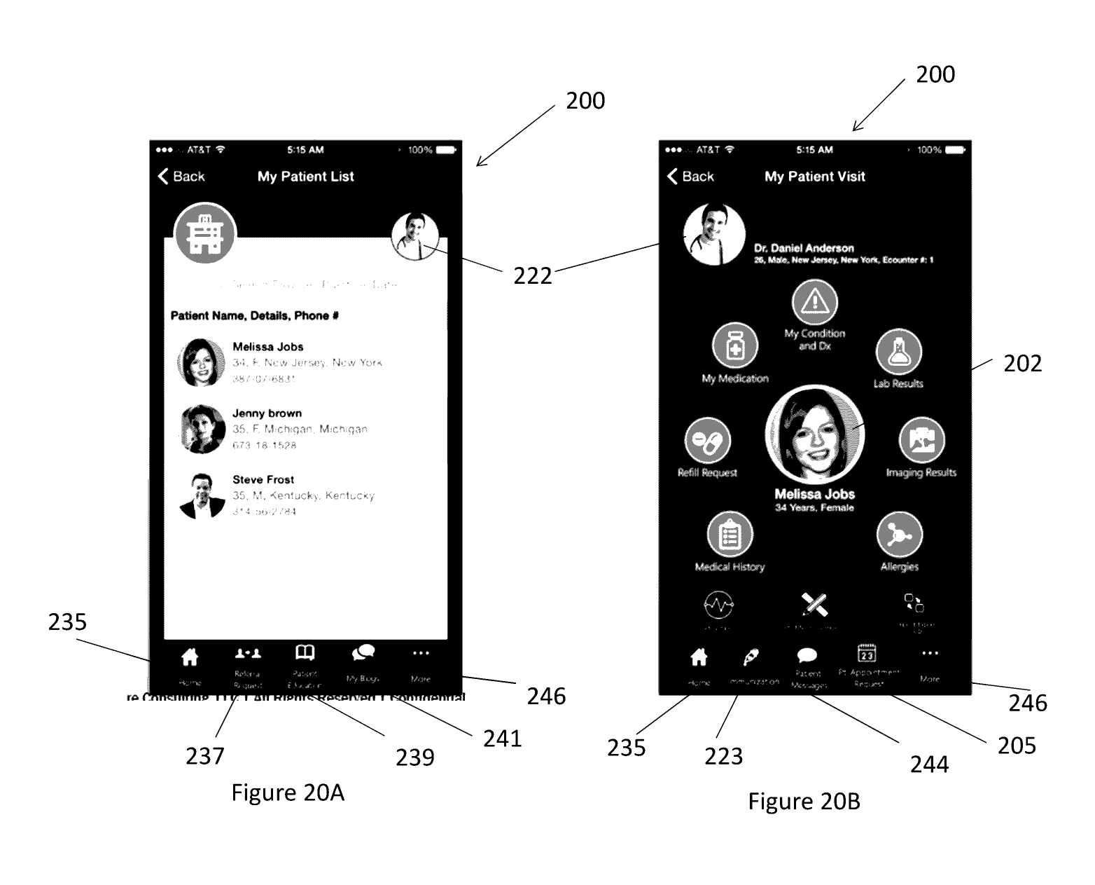

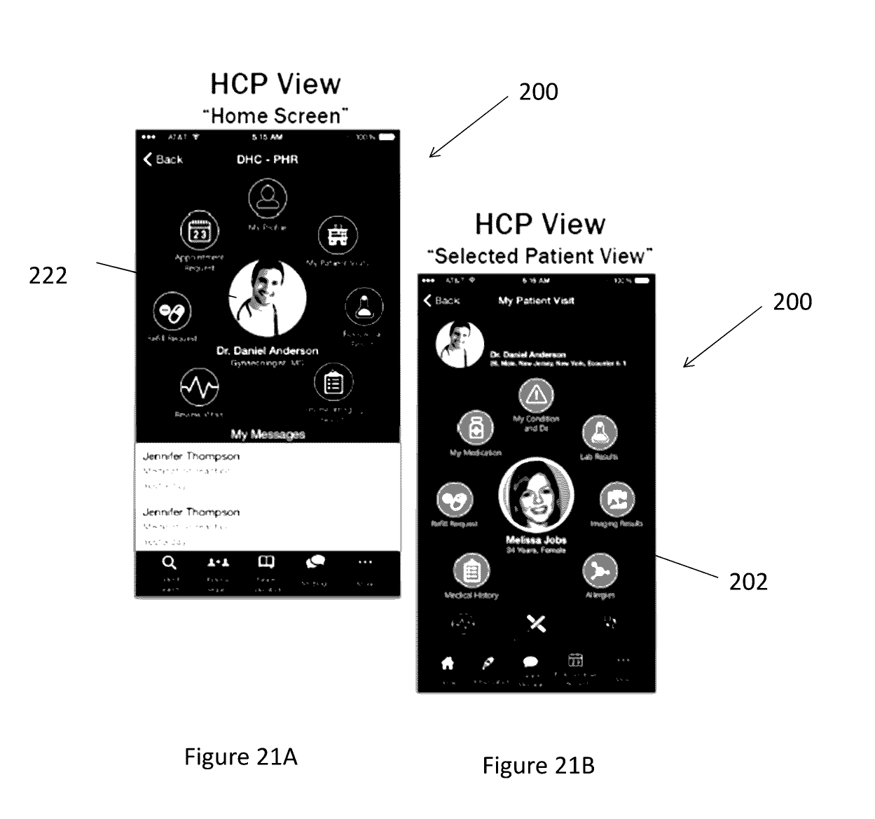

FIG. 20A through FIG. 21B illustrates an exemplary my patients 238 interface, which may provide the healthcare provider with a list of his or her patients. The healthcare provider 222 may select a particular patient 202 and a screen may be generated with icons providing links to that patient's 202 E-PHR information including the patient's 202 medical history, refill requests, medications, conditions and diagnoses, lab results, imaging results, allergies and the like. This list is intended to be exemplary and is not intended to be limiting. Any relevant medical information is contemplated. As best shown in FIG. 21A and FIG. 21B this interface is similar to the patient's 202 interface illustrated and discussed in FIG. 5.

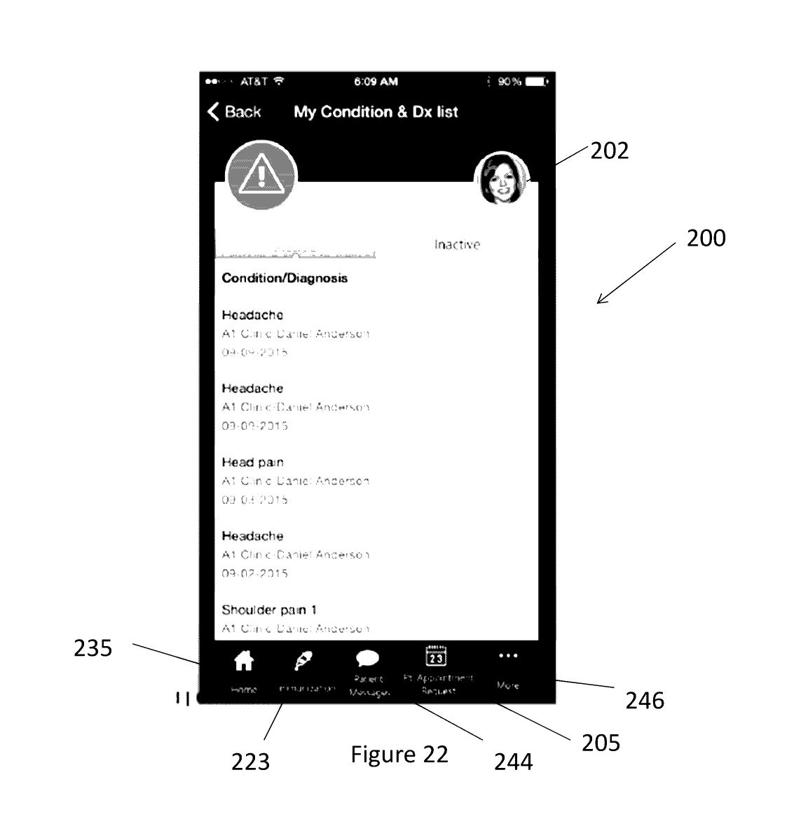

FIG. 22 illustrates the conditions and diagnoses link viewable by the healthcare provider 222. This is similar to the conditions and diagnoses link viewable by the patient as shown and discussed in FIG. 9A and FIG. 9B and may comprise many of the same features.

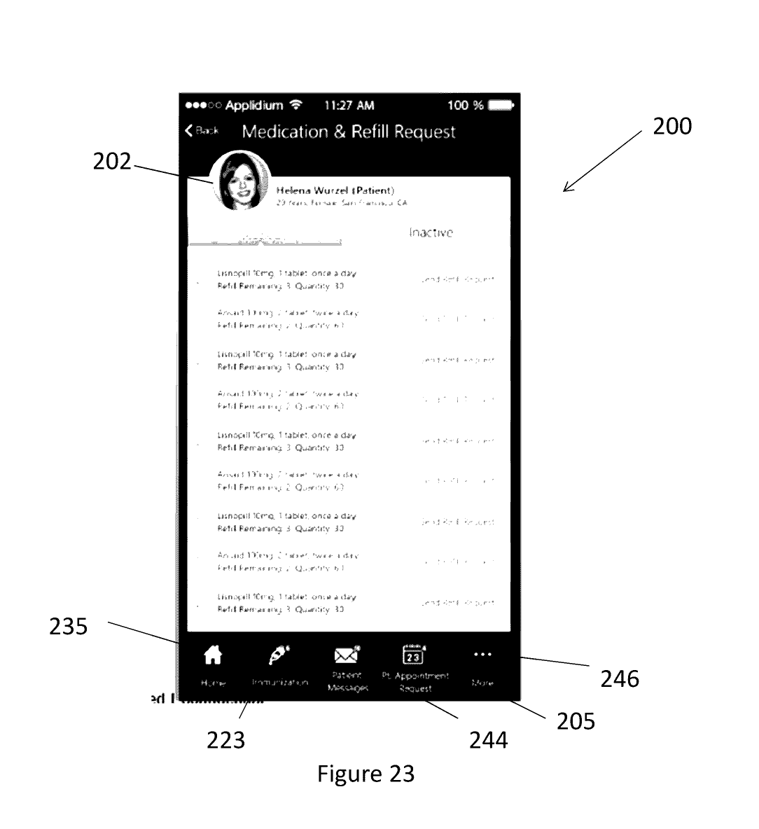

FIG. 23 illustrates the medication and refill requests link viewable by the healthcare provider 222. This is similar to the medication and refill requests link viewable by the patient as shown and discussed in FIG. 10A and FIG. 10B and may comprise many of the same features.

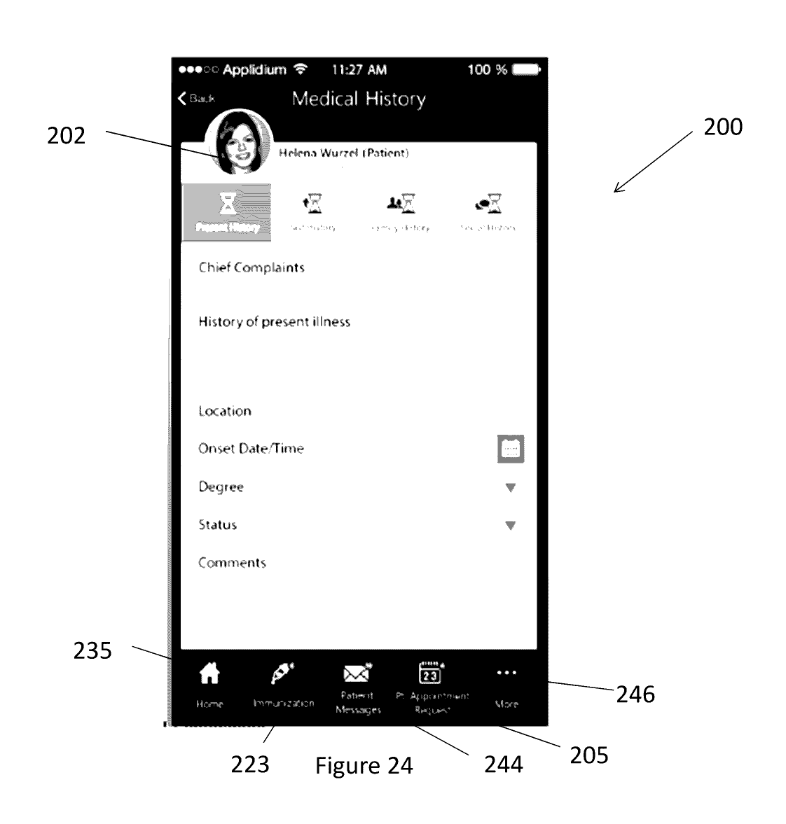

FIG. 24 illustrates the medical history link viewable by the healthcare provider 222. This is similar to the medical history link viewable by the patient as shown and discussed in FIG. 11 and may comprise many of the same features.

FIG. 25A through FIG. 29 illustrates an exemplary system that permits the healthcare provider 222 to transmit the standardized clinical document using the application 200 as well as preview and select what of the received standardized clinical documents to merge with the patient's 202 EMR. For example, but not to serve as a limitation, some or all of the E-PHR may be duplicative, unreliable, or irrelevant for the particular healthcare provider 222, and thus he or she may choose to reject it. Likewise, when sending the E-PHR from the healthcare provider 222 to the patient 202 the patient 202 may choose to accept or reject some or all of the E-PHR as the patient 202, for example without limitation, may not wish to store the information or may find it irrelevant, duplicative, or mistaken, and thus he or she may choose to reject it.

As best illustrated in FIG. 25A through FIG. 25E, once the healthcare provider 222 has received a standardized clinical document, the healthcare provider 222 may review it. After selecting the standardized clinical document from a list of received standardized clinical documents, a view, share, delete, and other options 260 may be presented by an action such as swiping in any or a particular direction, double tapping, single tapping, or the like. In other exemplary embodiments of the present invention, the view, share, delete, and other options 262 may always be visible. The view, share, and delete options 262 are merely exemplary, other relevant options are contemplated.

As best illustrated in FIG. 25C, upon selection, the standardized clinical document may be displayed for the healthcare provider's 222 review. As best illustrated in FIG. 25D, the healthcare provider 222 may then select some or all or the standardized clinical document for integration with the patient's 202 EMR. A select all option 276 may be available. As best illustrated in FIG. 25E, a confirmation message may be generated upon successful merger with the patient's 202 EMR.

The healthcare provider 222 may also transmit a standardized clinical document to a patient 202 or other healthcare provider 222. The healthcare provider 222 may use his or her E-PHR app 200 and may select the patient 202 whose EMR the healthcare provider 222 wishes to transmit. The patient 202 may be selected from a list of patients associated with the healthcare provider 222. The healthcare provider 222 may select some or all of the EMR for that patient 202 and may select the intended recipient(s) of said information. Generally, if not always, the healthcare provider 222 will first receive consent from the patient 202 to transmit their PHI. As previously discussed, the intended recipient(s) may be the patient 202 or various other healthcare providers 222, though any recipient is contemplated. In exemplary embodiments of the present invention, after sending the PHI the app 200 may generate a confirmation message.

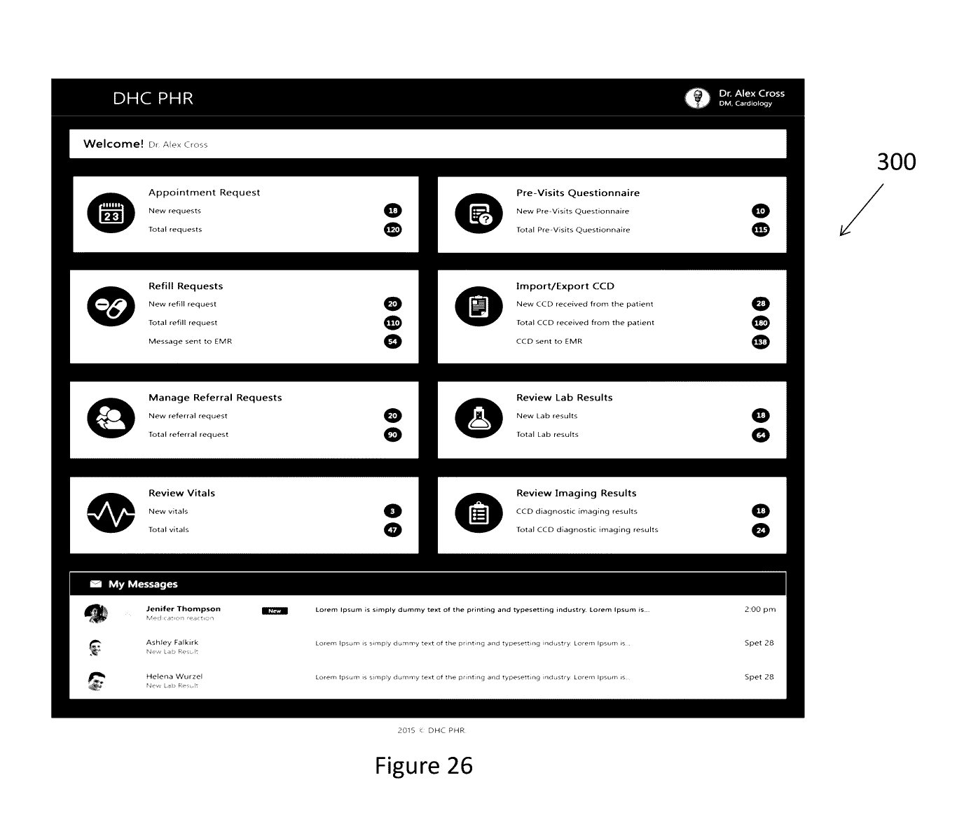

FIG. 26 illustrates another exemplary embodiment of the present invention, specifically of an administrative interface 300 for the healthcare provider's practice. For example, but without limitation, the administrative interface 300 may be used by the healthcare provider's 222 staff to assist in managing a practice. The administrative interface 300 may include administrative information such as the number of new appointment requests, imported/exported E-PHR information, lab results, patient education materials, refill requests, referral requests, imaging results, vitals, pre-visit questionnaires messages, blogs, and the like. This list is merely exemplary and is not intended to be limiting.

This information may be displayed solely for informational purposes, or alternatively, each may link to further information and allow the healthcare provider's 222 staff to edit, modify, delete, add to, or otherwise interact with the information. For example, but without limitation, the administrative interface 300 may be used to send and receive the pre-visit questionnaire and other paperwork as previously discussed. The administrative interface 300 may be a compilation of data from multiple healthcare provider's E-PHR apps 200. For example, but without limitation, the administrative interface 300 may compile information from all E-PHR applications 200 for all healthcare providers in a practice. The information may be sorted by healthcare provider, such that the displayed information is specific to a particular healthcare provider in the practice.

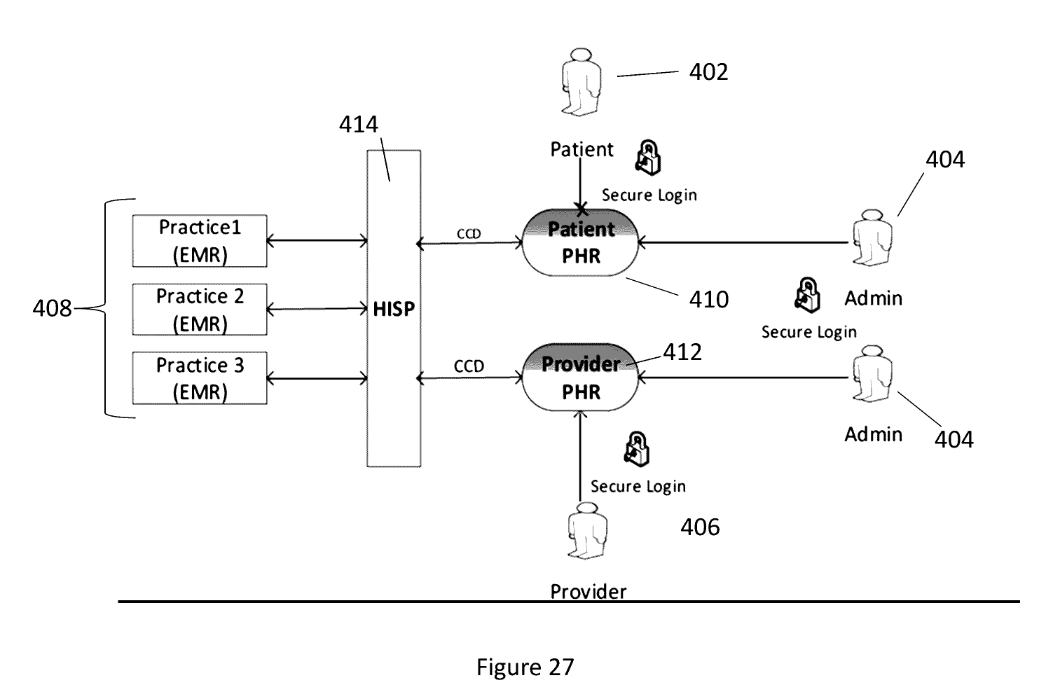

FIG. 27 illustrates another exemplary system in accordance with the present invention. Each patient 402 or healthcare provider 406 may be able to access his or her E-PHR application 410 and 412, respectively, through a login process. In exemplary embodiments of the present invention, an administrator 404 is also able to access each patient's or healthcare provider's E-PHR application 410 and 412 information, respectively, though a login process. This access may be via a web-based portal or the like. Each patient 402 or healthcare provider 406 may be able to transfer their entire E-PHR or portions thereof to a variety of healthcare providers or practices' 408 to be integrated with the healthcare provider's EMR systems. At the patient's direction, the E-PHR application 410 will transfer their E-PHR or portions thereof in the standardized clinical document to the HISP 414. The HISP 414 will then transfer the E-PHR or portions thereof to the various healthcare providers/practices 408 selected by the patient 402.

As previously discussed, the healthcare providers/practices 408 may then choose to accept or reject the information. The accepted information may then be integrated into the various healthcare providers/practices' 408 EMRs. Similarly, the various healthcare providers/practices 408 may send some or all of the patient's EMR to the patient 402 or another healthcare provider 406 by converting the EMR to the standardized clinical document and transmit it to the E-PHR application 410. The healthcare provider 408 may select the intended recipients and transmit the standardized clinical document to them via the HISP 414. The HISP 414 may send the standardized clinical document to each patient's E-PHR 410 to be accepted or rejected, processed, and stored. In exemplary embodiments of the present invention, the healthcare provider 406 may use the same system and method to transmit some or all of the patient's 402 E-PHR to the patient's various healthcare providers 408 using the healthcare provider's E-PHR application 412.

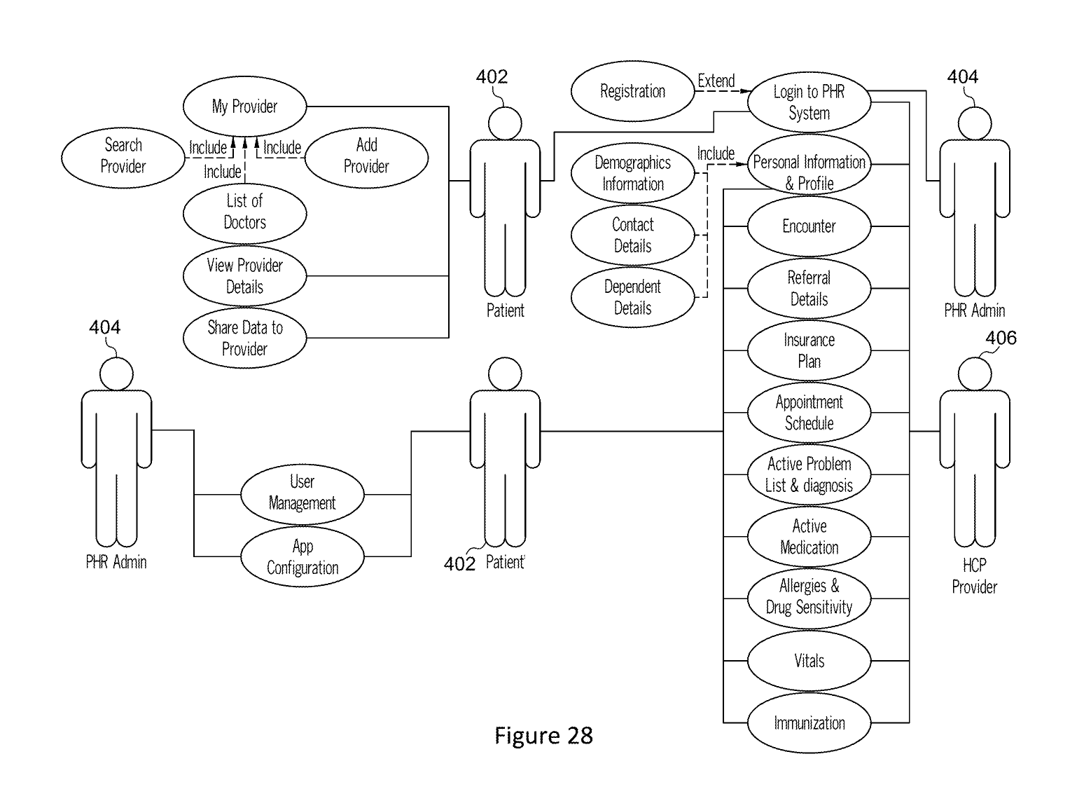

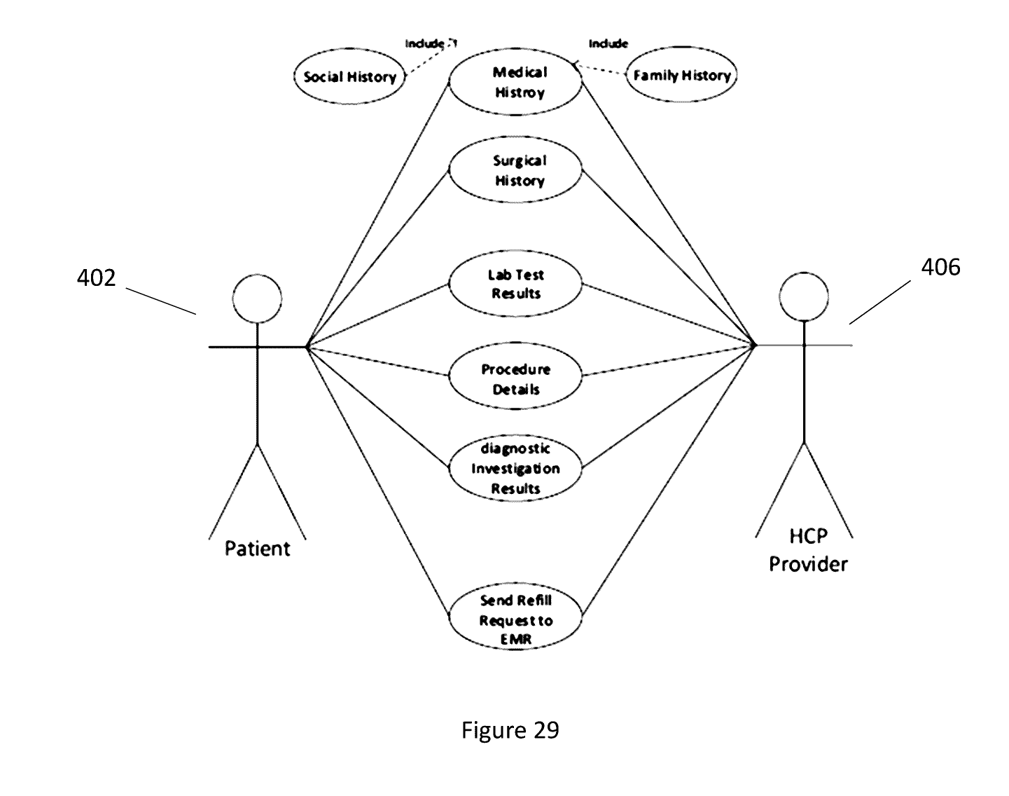

FIG. 28 illustrates what information each party may have access to and may share with one another. FIG. 29 is a detailed view of the relationships in FIG. 28, illustrating the information that the healthcare provider 406 and the patient 402 may have access to and share with one another. The lists and relationships illustrated in FIG. 28 and FIG. 29 are merely exemplary and not intended to be limiting.

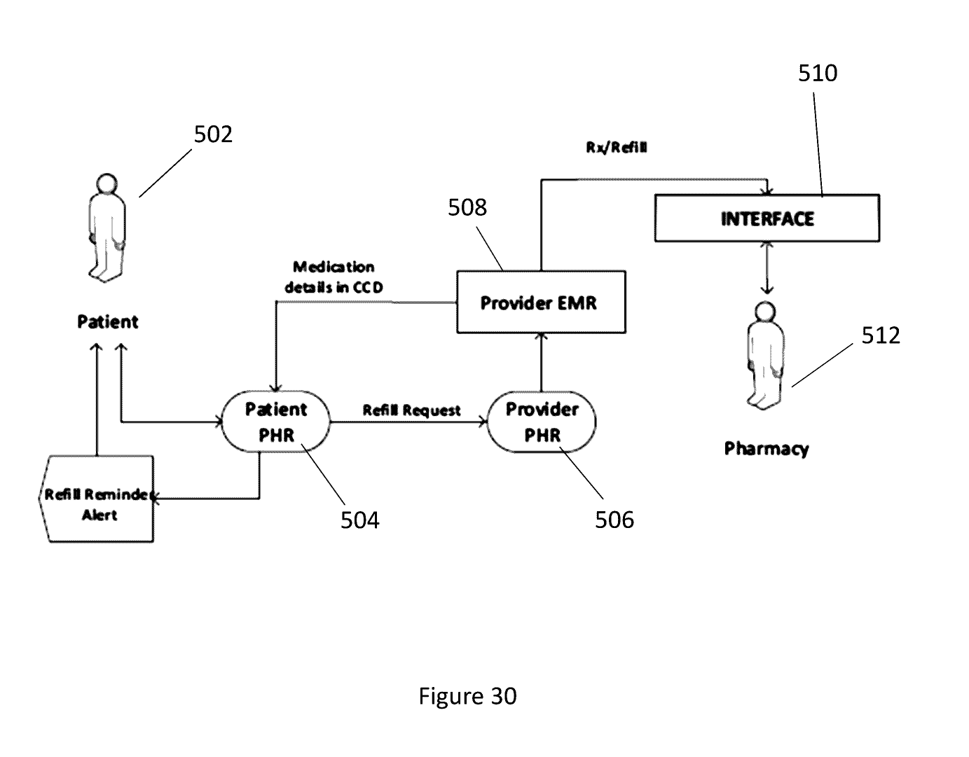

FIG. 30 illustrates another exemplary system in accordance with the present invention, specifically for a pharmacy prescription refill using the app. A patient 502 may utilize his or her E-PHR application 504 to request a prescription refill. The request may be transmitted to the healthcare provider's E-PHR application 506. The healthcare provider may use their E-PHR application 506 or their EMR system to see if the patient has any remaining refills available on his or her current prescription. If so, the healthcare provider may transmit the refill request through the healthcare provider's EMR 508 to the pharmacy 512 by way of an interface 510. If no refills remain, the refill request may be transmitted to the healthcare provider's E-PHR application 506 for the healthcare provider's approval. Once approved, the healthcare provider's E-PHR app 506 may transmit the request through the EMR 508 system (or directly from the E-PHR application 506) to the pharmacy 512 by way of the interface 510.

In exemplary embodiments of the present invention, the refill request may be transmitted directly to the pharmacy 512 or the pharmacy's interface 510 through the provider's E-PHR application 506. The pharmacy may notify the provider and the patient that the prescription has been refilled via the interface 510 and each party's E-PHR 506 and 504. The healthcare provider's EMR 508 may also update the medication and refill details in their EMR system and transmit that information to the patient's E-PHR application 504. The healthcare provider's E-PHR application 506 will also be updated when the request is received and approved. In still other exemplary embodiments, the refill request may be transmitted directly to the pharmacy 512 or the pharmacy's interface 510 through the patient's E-PHR application 504.

In exemplary embodiments of the present invention, the patient's E-PHR 504 may generate an alert when the prescription is available for pick up. The alert may be a notification, message, email, text, audible noise, visual effect, or the like. In still other exemplary embodiments, the patient's E-PHR 504 may generate a refill reminder when the patient's 502 prescription is likely in low supply as determined from the scheduled dosage and prescription.

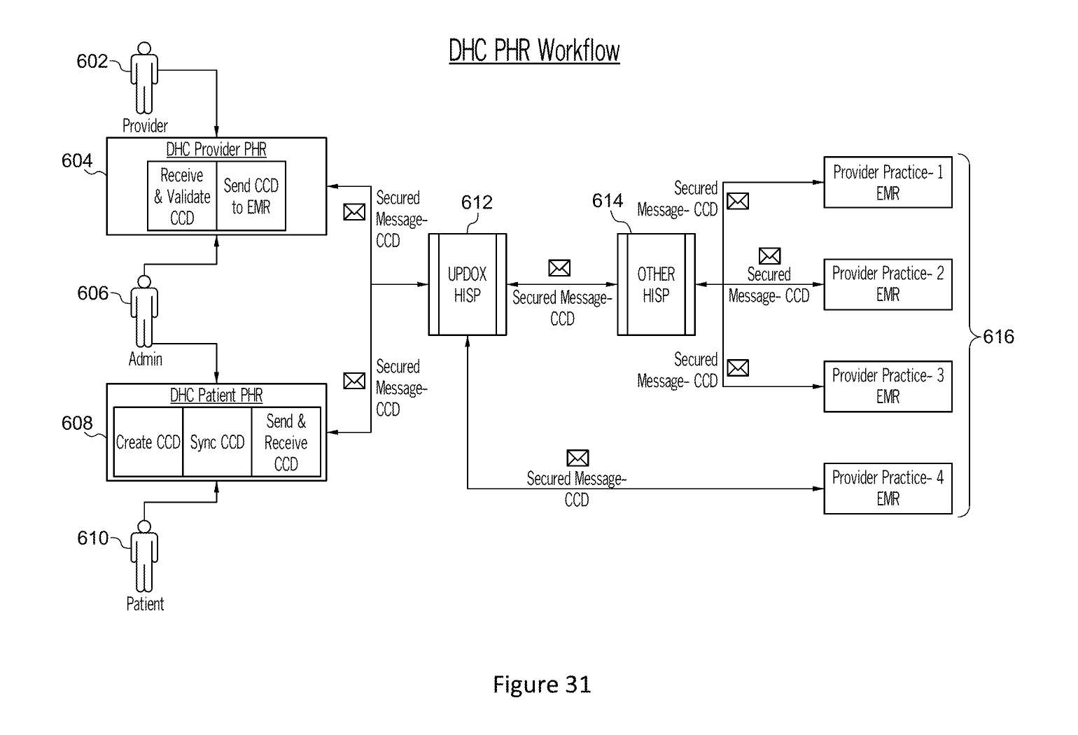

FIG. 31 illustrates another exemplary embodiment of a system in accordance with the present invention, specifically for the secure communication messages and data, including the standardized clinical documents, between the patient and the various healthcare providers. A healthcare provider 602 may communicate the standardized clinical document, such as but not limited to the CCD or the like, to a patient and the patient's various other healthcare providers 616. Similarly, a patient 610 may communicate standardized clinical document to their various healthcare provider's 616. The patient 610 may utilize his or her E-PHR application 608 to create the communication and then sync, send, transmit, or otherwise communicate the communication to the healthcare provider's E-PHR application 604. The communication may be a message, email, text, standardized clinical document, or the like. The communication may be transmitted through at least one HISP. For example, without limitation, the communication may be first transmitted to the UPDOX HISP 612. The various healthcare providers 616 who are able to communicate directly with the UPDOX HISP 612 may receive the communication directly from the UPDOX HISP 612. For the various healthcare providers 616 who are not able to communicate directly with the UPDOX HISP 612, the communication or the like may be transmitted through another HISP 614 from which they may receive the communication.

This process may flow in reverse when one of the various healthcare provider's 616 transmits a communication back to the patient 610. Similarly, this same process and system may be utilized to send and receive communication from the healthcare provider 602 to the patient 610 or to the patient's various other healthcare providers 616. Additionally, an administrator 606 may be granted access to the various E-PHR applications 604 or 608.

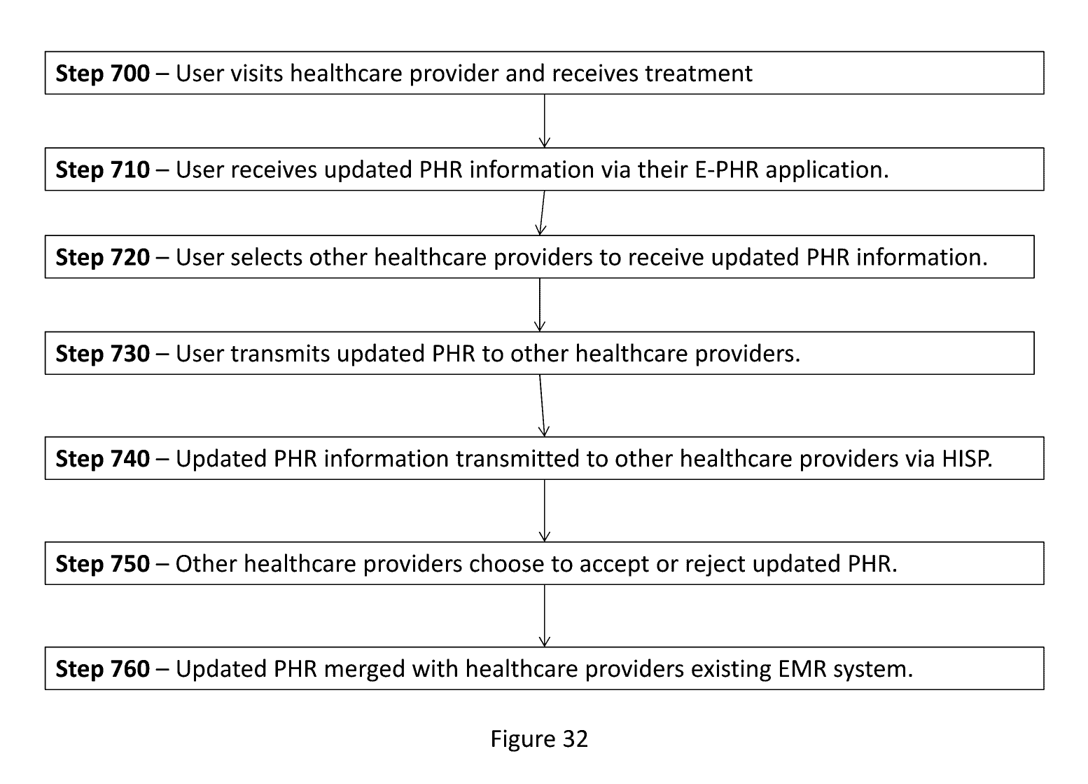

FIG. 32 describes an exemplary system and method in accordance with the present invention. In Step 700 a patient may visit a healthcare provider and receive treatment. The healthcare provider may update the patient's PHI using their EMR system. In Step 710 the provider's E-PHR application may send the updated PHI or other information to the patient via the patient's E-PHR application. In Step 720 the patient may select other healthcare providers to receive some or all of the updated E-PHR information and in Step 730 the patient may transmit the updated E-PHR to the other healthcare providers. The E-PHR information may be sent in the form of the standardized clinical document, such as the CCD or the like. In Step 740, the updated E-PHR may be transmitted to other healthcare providers via one or more HISPs. Various HISPs may be used as required to interface with the various healthcare provider's EMR systems. Upon receipt of the updated E-PHR, the various healthcare providers may choose to accept or reject all or a portion of the updated E-PHR information in Step 750. Finally, in Step 760 the updated E-PHR is merged with the healthcare providers' existing EMR system.

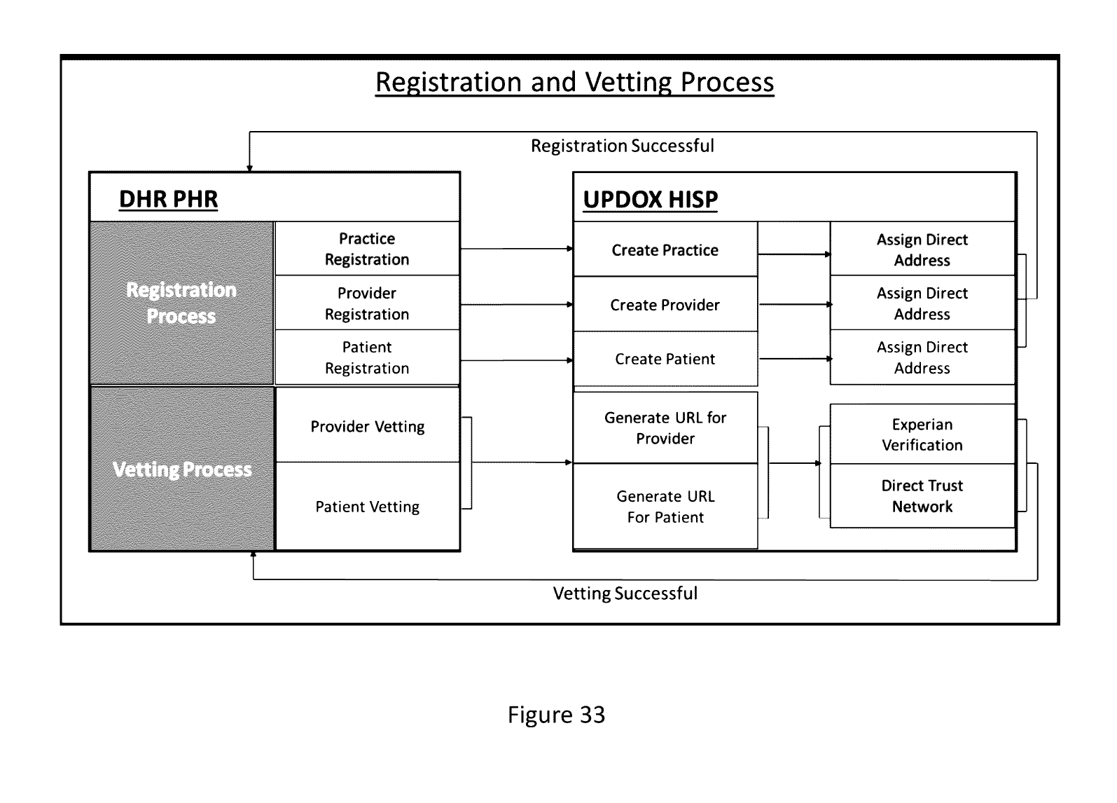

FIG. 33 is an exemplary registration and vetting process that may be used upon initial registration by a new patient or healthcare provider. This registration and/or vetting process may be utilized in conjunction with any of the embodiments described herein. The registration and vetting process may require registration and vetting for the patient and the healthcare provider not only with the E-PHR app 16 but also with the HISP systems used in conjunction with the E-PHR app 16. The process may be substantially the same for any user, or may have specific steps depending on whether the user is the patient, the healthcare provider, an individual associated with the healthcare provider (for example, without limitation, an employee, staff, assistant, contractor, insurance company personnel, pharmacy personnel or the like), or the system administrator.

The user may provide personal information such as their name and email address, office or company name, address, and the like. The E-PHR app 16 may add the user to the system and request the HISP to add the user. The HISP may assign an ID number or other identifying marker to the user and the E-PHR app 16 may associate the assigned ID number or other identifying marker with the user, completing the registration process. The HISP may also assign a secured email account for each user.

The E-PHR app 16 may also vet the user by conventional methods, such as generating and sending a confirmation URL to the user's registered email to activate their account, or the like. The HISP system may likewise vet the user by conventional methods. The HISP may further utilize a commercial identify verification service, such as but not limited to Experian (http://www.experian.com/decision-analytics/identity-and-fraud/identity-verification-screening.html) or the Direct Trust Network (https://www.directtrust.org/). Upon successful registration and/or verification the user's account may be activated and used normally.

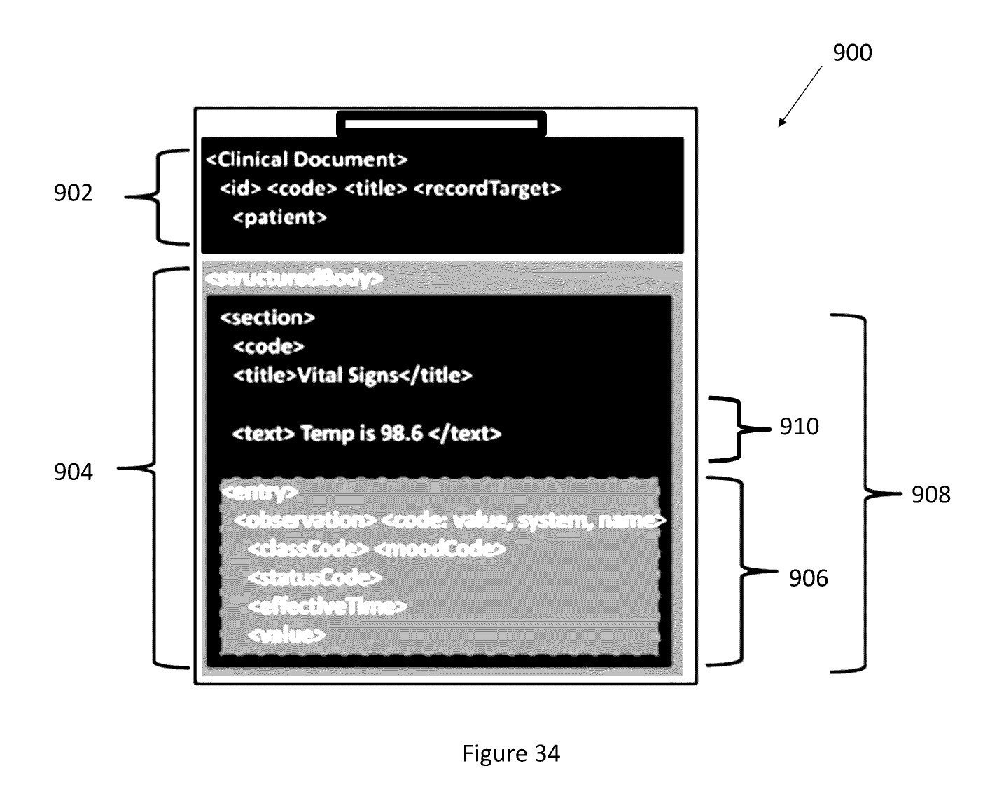

FIG. 34 illustrates an exemplary structure for the CCD 900. It is notable that this structure is merely exemplary and not intended to be limiting. As discussed, the CCD 900 may be created using any communications and formatting protocol, such as but not limited to the CDA or the CCDA. The illustrated example is created using the CDA which utilizes the Health Level Seven (http://www.hl7.org/implement/standards/) Reference Information Model. One having skill in the arts will appreciate that the present invention is not limited to the current structure or standards and contemplates both the current and future structures and standards or protocols for the CCD 900, CDA, C-CDA, or the like. The CCD 900 may be structured with a header 902 comprising code which generates a title. The header 902 may set the context for the CCD 900 as a whole and facilitate the CCD's 900 exchange across and within institutions, its management, and its compilation into the E-PHR.

The header 902 may be followed by a body 904, which contains the clinical report. The body 904 may be unstructured or may comprise one or more sections 908, each of which may comprise code for a narrative block 910 and one or more entries 906. Each of the sections 908 may comprise any type of data including, but not limited to, data pertaining to allergies, meds, problems, immunizations, vital signs, and the like. The narrative block 910 may be coded to allow human-readability of the CCD 900 by formatting the content for viewing. The narrative block 910 may have a fixed markup and be populated by the document originator. The entry 906 may be coded to allow machine readability.

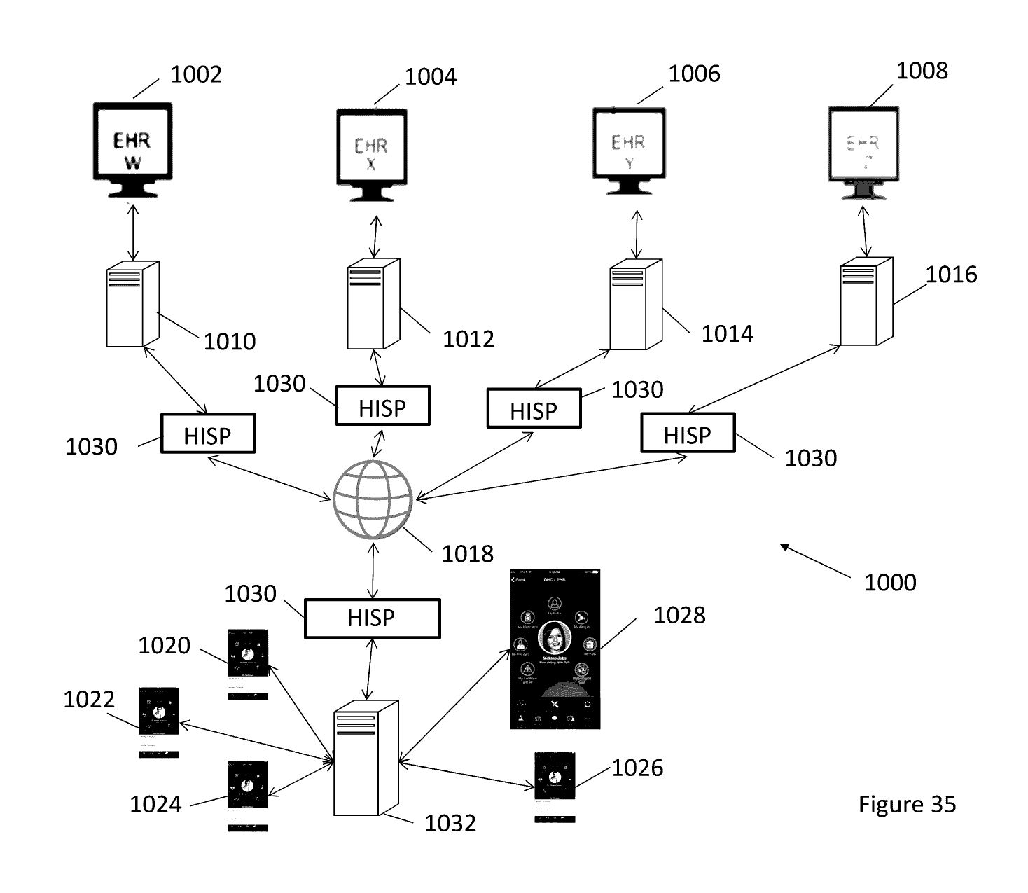

FIG. 35 illustrates another exemplary system in accordance with the present invention. The E-PHR system 1000 may comprise a series of EMR systems 1002, 1004, 1006, 1008 for each healthcare provider. Any number of EMR systems for any number of healthcare providers is contemplated. Each EMR system 1002, 1004, 1006, and 1008 may be in communication with a networked database 1010, 1012, 1014, and 1016, respectively. The networked databases 1010, 1012, 1014, 1016 may store the EMR and related information for each healthcare provider. The networked databases 1010, 1012, 1014, 1016 may each be in communication with another HISP 1030 which may be in communication with a communications network 1018 such as, but not limited to, the world wide web. The communications network 1018 may be in communication with yet another HISP 1030 which may be in communication with an E-PHR database 1032. The HISPs 1030 may be the same or may be different for some or all of the E-PHR app users. The E-PHR database 1032 may comprise the patient's E-PHR, which as previously discussed is a compilation of the patient's standardized clinical documents from each of the patient's healthcare providers.

The patient may access their E-PHR by way of the patient's E-PHR app 1028. As previously discussed, the patient may transfer some or all of his or her E-PHR to the patient's various healthcare providers. The various healthcare providers may choose to accept or reject the information, and the accepted information may be integrated with the healthcare provider's EMR systems 1002, 1004, 1006, 1008. The healthcare provider's E-PHR app 1020, 1022, 1024, 1026 may be in communication with their EMR systems 1002, 1004, 1006, 1008 and the corresponding networked databases 1010, 1012, 1014, 1016 by way of the HISPs 1030. The healthcare provider's E-PHR app 1020, 1022, 1024, 1026 may translate the standardized clinical document by formatting it for human consumption and organizing the content in a user friendly way such that the healthcare providers may view the transmitted E-PHR information before deciding whether or not to integrate the transmitted PHI with their EMR system 1002, 1004, 1006, 1008.

Likewise, the standardized clinical document may be viewed by the patient through the patient E-PHR app 1028, which may translate the standardized clinical document by formatting it for human consumption and organizing the content in a user friendly way such that the user may view the transmitted personal health information before deciding whether or not to integrate the transmitted personal health information with their E-PHR. Further, this may allow the healthcare providers E-PHRs apps 1020, 1022, 1024, and 1026 and the patient E-PHR app 1028 to sync with one another and store other information such as appointment reminders, patient lists, healthcare providers list, and the like. In exemplary embodiments, this information does not need to be converted to a standardized clinical document to be transmitted, but is stored in the E-PHR database 1032 and automatically updated on or synchronized with both the appropriate healthcare providers E-PHRs apps 1020, 1022, 1024, and 1026 and the appropriate patient's E-PHR 1028.

The E-PHR database 1032 may comprise multiple independent databases that may be physically, electronically, or otherwise partitioned in order to separate the data for the healthcare providers E-PHRs apps 1020, 1022, 1024, and 1026 and the patient E-PHR app 1028. The E-PHR database 1032 may be part of “the cloud” or a shared resources database.

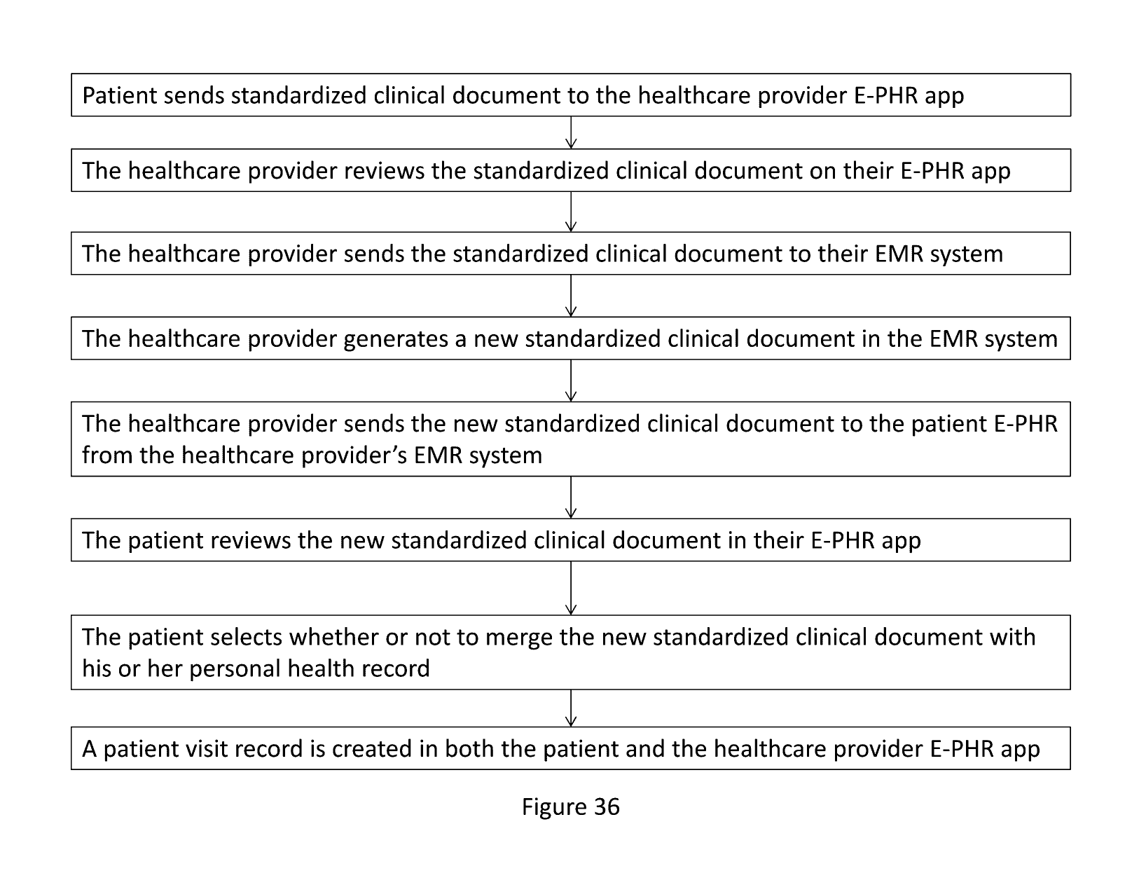

FIG. 36 is an exemplary method of how the E-PHR app may be utilized when visiting a healthcare provider who does have or use the E-PHR application. This method may be used in conjunction with the system of FIG. 35 or any of the other systems or methods described herein. The patient may send a standardized clinical document to the healthcare provider by way of the patient's E-PHR app. In exemplary embodiments, the standardized clinical document may comprise the patient's E-PHR. The healthcare provider may review the standardized clinical document on his or her E-PHR app and select whether or not to integrate some or all of the standardized clinical document with their EMR system. The selected portions of the standardized clinical document may be sent to and integrated with the healthcare providers EMR system.

After or during the visit the healthcare provider may generate a new standardized clinical document comprising the new information from the visit or the patient's entire EMR with the updated information from the visit. Regardless, the new standardized clinical document may be sent to the patient's E-PHR app by way of the healthcare provider's EMR system. The patient may then review the new standardized clinical document on his or her E-PHR app. The patient may then select some or all of the new standardized clinical document to be integrated with his or her personal health record. The selected portions of the new standardized clinical document may then be integrated with the patient's E-PHR, stored, and be made available to the patient by way of his or her E-PHR app.

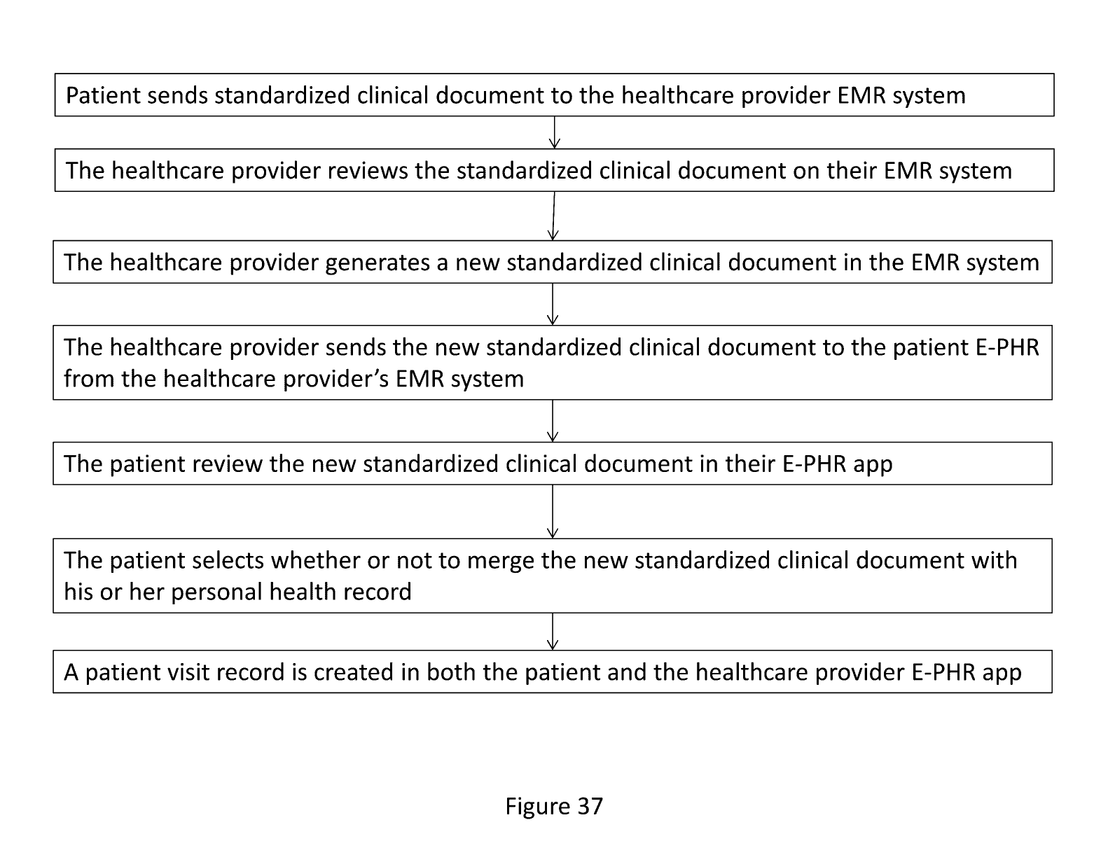

FIG. 37 is an exemplary method of how the E-PHR app may be utilized when visiting a healthcare provider who does not have or use the E-PHR application. This method may be used in conjunction with the system of FIG. 35 or any of the other systems or methods described herein. This method is similar to that of FIG. 36 with the notable exception that the patient sends the standardized clinical document to the healthcare provider's EMR system, as the healthcare provider does not have the E-PHR app. Additionally, the healthcare provider does not need to send the standardized clinical document to his or her EMR system as it has already been sent there.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for compiling a patient's personal health data stored in one or more healthcare providers' electronic medical records systems comprising:
at least one healthcare provider application wherein each of the healthcare provider applications are configured to interface with each of the one or more healthcare providers' electronic medical records system and permit the healthcare provider to display and interact with a standardized clinical document by formatting the standardized clinical document for human consumption, wherein the one or more electronic medical records systems each comprise a networked database configured to record the patient's personal health data and selectively convert some or all of the patient's electronic medical record into the standardized clinical document and a healthcare provider electronic device in communication with the networked database configured to display the patient's personal health data;
a personal health record database in communication with the at least one healthcare provider application and the one or more healthcare providers' electronic medical records systems, wherein the personal health record database is configured to receive the standardized clinical document from the one or more healthcare providers' electronic medical records systems and selectively integrate the received standardized documents into a personal health record, wherein the personal health record is controlled by the patient and comprises the patient's personal health data compiled from one or more of the patient's healthcare providers;
a patient application configured to provide access to the personal health record database, display and permit interaction with the personal health record, display and permit interaction with received standardized clinical documents by formatting the standardized clinical document for human consumption, permit selective acceptance or rejection of the received standardized clinical documents, selectively convert some or all of the personal health record into the standardized clinical document, and selectively transmit the standardized clinical document to the one or more healthcare providers' applications;
at least one healthcare information service in communication with the personal health records database and the networked databases configured to receive, encrypt, certify, and transmit the standardized clinical document; and
a healthcare administrator application configured to interface with one or more of the healthcare provider applications and provide an overview of activity on all of the healthcare provider applications associated with a healthcare practice;
wherein the patient application is accessible by way of an electronic device operable by the patient;
wherein each of the healthcare provider applications are accessible by way of a healthcare provider electronic device operable by the healthcare provider;
wherein the healthcare provider application is configured to permit selective acceptance or rejection of the received standardized clinical documents and integrate the accepted standardized clinical documents into the healthcare provider's electronic medical records system.

2. The system of claim 1 wherein:
each of the healthcare provider applications are further configured to interface with a prescription system.

3. The system of claim 2 wherein:
the healthcare provider application is configured to transmit prescription requests to the prescription system.

4. The system of claim 3 wherein:
the healthcare provider application is configured to convert the patient's prescription information into the standardized clinical document and transmit the standardized clinical document to the personal health record database.

5. The system of claim 1 wherein:
the personal health record database is configured to store personal health data regarding the patient's conditions and diagnoses;
the patient application is configured to display and permit interaction with the personal health data regarding the patient's conditions and diagnoses;
the networked databases are configured to store the personal health data regarding the patient's conditions and diagnoses; and
the healthcare provider application is configured to display and permit interaction with the personal health data regarding the patient's conditions and diagnoses.

6. The system of claim 1 wherein:
the personal health record database is configured to store personal health data regarding the patient's medications and prescriptions;
the patient application is configured to display and permit interaction with the personal health data regarding the patient's medications and prescriptions;
the networked databases are configured to store the personal health data regarding the patient's medications and prescriptions; and
the healthcare provider application is configured to display and permit interaction with the personal health data regarding the patient's medications and prescriptions.

7. The system of claim 1 wherein:
the personal health record database is configured to store personal health data regarding the patient's laboratory tests and results;
the patient application is configured to display and permit interaction with the personal health data regarding the patient's laboratory tests and results;
the networked databases are configured to store the personal health data regarding the patient's laboratory tests and results; and
the healthcare provider application is configured to display and permit interaction with the personal health data regarding the patient's laboratory tests and results.

8. The system of claim 1 wherein:
the personal health record database is configured to store data regarding the patient's healthcare providers;
the patient application is configured to display and permit interaction with the personal health data regarding the patient's healthcare providers;
the networked databases are configured to store the personal health data regarding the healthcare provider's patients; and
the healthcare provider application is configured to display and permit interaction with the personal health data regarding the healthcare provider's patients.

9. The system of claim 1 wherein:
the personal health record database is configured to store electronic communications from the healthcare provider;
the patient application is configured to display and permit interaction with the electronic communications from the healthcare provider;
the networked databases are configured to store electronic communications from the patient; and
the healthcare provider's application is configured to store, display, and permit interaction with electronic communications from the patient.

10. The system of claim 1 wherein:
the healthcare provider application is configured to transmit a pre-visit questionnaire and paperwork to the patient application in advance of the patient's appointment with the healthcare provider.

11. The system of claim 10 wherein:
the patient application is configured to automatically populate the pre-visit questionnaire and paperwork with the data stored in the personal health record database.

12. The system of claim 1 wherein:
the patient application is a web-based application.

13. The system of claim 1 wherein:
the patient application is configured to receive personal health data from a digital sensor and is configured to convert the personal health data into the standardized clinical document and transmit the standardized clinical document to the personal health record database for integration with the personal health record.

14. The system of claim 1 wherein:
the patient application is configured to receive personal health data from a fitness tracking device and is configured to convert the personal health data into the standardized clinical document and transmit the standardized clinical document to the personal health record database for integration with the personal health record.

15. A system for compiling a patient's personal health data stored in one or more healthcare providers' electronic medical records systems comprising:
a healthcare provider interface configured to interface with the healthcare providers' electronic medical records system, display and permit interaction with a standardized clinical document by formatting the standardized clinical document for human consumption, and selectively convert some or all of the patient's electronic medical record into the standardized clinical document, wherein each of the one or more healthcare providers' electronic medical record systems comprises a networked database configured to record the patient's personal health data;
a patient interface comprising:
a personal health record database in communication with the one or more healthcare providers' electronic medical records systems and configured to receive, compile, and integrate the received standardized documents into a personal health record wherein the personal health record is patient controlled and comprises the patient's personal health data compiled from one or more of the patient's healthcare providers; and
a patient application configured to provide access to the personal health record database, display and permit interaction with the personal health record, display and permit interaction with the received standardized clinical documents by formatting the standardized clinical document for human consumption, selectively convert some or all of the personal health record into the standardized clinical document, and selectively transmit the standardized clinical document to one or more of the healthcare providers' interface; and
at least one healthcare information service in communication with the personal health records database and the networked databases configured to receive and transmit the standardized clinical document;
wherein the patient application is installed on a first electronic device operable by the patient;
wherein the healthcare provider interface is installed on a second electronic device operable by the healthcare provider;
wherein the patient interface and the healthcare provider interface are each configured to permit selective acceptance or rejection of received standardized clinical documents.

16. The system of claim 15 further comprising:
a healthcare administrator application configured to interface with one or more of the healthcare provider interfaces and provide an overview of activity on all of the healthcare provider interfaces associated with a healthcare practice.

17. The system of claim 15 further comprising:
a communication exchange medium configured to receive and transmit the standardized clinical document between the patient interface and the healthcare provider interface or between two or more of the healthcare provider interfaces using a communications protocol.

18. The system of claim 15 further comprising:
a healthcare administrator interface configured to interface with one or more of the healthcare provider interfaces and provide an overview of activity on all of the healthcare provider interfaces associated with a healthcare practice.

19. The system of claim 15 wherein:
the healthcare provider interface is configured to transmit a pre-visit questionnaire and paperwork to the patient interface in advance of the patient's appointment with the healthcare provider; and
the patient interface is configured to automatically populate the pre-visit questionnaire and paperwork with the data stored in the personal health record database.

20. A system for compiling a patient's personal health data stored in one or more healthcare providers' electronic medical records systems comprising:
at least one healthcare provider application configured to interface with the one or more healthcare providers' electronic medical records systems and display and permit interaction with a standardized clinical document by formatting the standardized clinical document for human consumption, wherein the one or more electronic medical records systems each comprise a networked database configured to record the patient's personal health data and selectively transform some or all of the patient's electronic medical record into the standardized clinical document and a healthcare provider electronic device in communication with the networked database and configured to display the patient's personal health data;
a personal health record database in communication with the one or more healthcare providers' electronic medical records systems and the healthcare provider application, wherein the personal health record database is configured to receive the standardized clinical document from the one or more healthcare providers' electronic medical records systems, compile and integrate the received standardized documents into a personal health record, and store the personal health record;
a patient application configured to provide access to the personal health record database, display and permit interaction with the personal health record, display and permit interaction with the standardized clinical document by formatting it for human consumption, selectively transform some or all of the personal health record into the standardized clinical document, selectively transmit the standardized clinical document to the one or more healthcare providers' electronic medical records systems, receive personal health data from a wellness monitoring device, and integrate the personal health data received from the wellness monitoring device into the personal health record;
at least one healthcare information service in communication with the personal health records database and the networked databases configured to receive and transmit the standardized clinical document; and
a healthcare administrator application configured to interface with one or more of the healthcare provider interfaces and provide an overview of activity on all of the healthcare provider interfaces associated with a healthcare practice;
wherein the patient application is accessible through an electronic device operable by the patient;
wherein each of the at least one healthcare provider applications are accessible through a healthcare provider electronic device operable by the healthcare provider;
wherein the healthcare administrator application is accessible through an administrator electronic device operable by the healthcare provider's administrator;
wherein the personal health record comprises the patient's personal health data compiled from one or more of the patient's healthcare providers and is controlled by the patient;
wherein the personal health record database is further configured to store other medical information to be synchronized between the healthcare provider application, the healthcare administrator application, and the patient application.
